(19) United States
(12) Patent Application Publication
(10) Pub. No.: US 2017/0330434 A1
(43) Pub. Date: Nov. 16, 2017

(54) FLOW LINE ANALYSIS SYSTEM AND FLOW LINE DISPLAY METHOD

(71) Applicant: Panasonic Intellectual Property Management Co., Ltd., Osaka (JP)

(72) Inventors: Hideaki TAKAHASHI, FUKUOKA (JP); Tetsuo TAYAMA, FUKUOKA (JP); Takae OGUCHI, FUKUOKA (JP); Shinpei HAGISU, FUKUOKA (JP)

(73) Assignee: Panasonic Intellectual Property Management Co., Ltd., Osaka (JP)

(21) Appl. No.: 15/536,572

(22) PCT Filed: Mar. 23, 2016
(86) PCT No.: PCT/JP2016/001685

§ 371 Date: Jun. 15, 2017

(30) Foreign Application Priority Data
Jun. 15, 2015 (JP) 2015-120646

(51) Int. Cl. G08B 13/196; G06F 17/30; G06T 7/292

(52) U.S. Cl. CPC G08B 13/19645; G06T 7/292; G06F 17/30244

(57) ABSTRACT

Displayed is a flow line analysis image in which the privacy of a person reflected in a wide imaging region is appropriately protected, and staying information or passing information of a person in the wide imaging region can be easily and accurately recognized. A camera includes an imaging section that captures an image of a differing imaging region for each camera, a background image generating section that repeatedly generates a background image of a captured image of the imaging region at predetermined timings, a flow line information analyzing section that extracts flow line information regarding a staying position or a passing position of a moving object in the imaging region of the camera, included in the captured image, and a transmitter that transmits the background image and the flow line information of the moving object to a server at a predetermined transmission cycle. A server includes an image generating section that acquires flow line analysis images based on superimposition between the background image of the captured image and the flow line information of the moving object for each camera, and generates a wide-region flow line analysis image by using the plurality of acquired flow line analysis images, and a display control section that displays the wide-region flow line analysis image on a display section.

### TECHNICAL FIELD

The present disclosure relates to a flow line analysis system, and a flow line display method capable of displaying a flow line analysis image in which staying information or passing information of a person is superimposed on an image captured by a camera.

### BACKGROUND ART

As the related art in which a level of activity of a person over a period of time at an imaging site where a camera is provided is displayed as a heat map image, for example, PTL 1 is known.

PTL 1 discloses a technique of analyzing a flow line of a person at the imaging site where a security camera connected to a network is provided so as to calculate a level of activity, generating a heat map image in which a detection result from a sensor is superimposed on a floor plan of the imaging site, and displaying the heat map image on a browser screen corresponding to the security camera. Consequently, it is possible to understand a level of activity of the person at the imaging site by viewing the heat map image displayed on the browser screen.

A technique has also been proposed in which a heat map image is generated by superimposing a flow line density of a person or a detection result of the number of people on an image captured by a camera unlike on the floor plan described in the PTL 1, and is then displayed (for example, refer to NPL 1).

Here, in a case where a detection result from the sensor is superimposed on the floor plan in PTL 1, the floor plan is required to accurately match an image of the imaging site captured by the security camera, but since the floor plan is invariable in PTL 1, the floor plan as a base of a heat map image matches the image.

### CITATION LIST

### Patent Literature

PTL 1: Japanese Patent Unexamined Publication No. 2009-134688

### Non-Patent Literature

NPL 1: “360° view is possible with only one camera! Innovative monitoring camera MOBOTIX Q24”, [online], OPN Corporation, 2014, [retrieved on Jun. 16, 2014, Retrieved from the Internet: <URL: http://www.opn-web.com/mobotix/index.htm>

### SUMMARY OF THE INVENTION

Here, a case is assumed in which a camera captures an image of a predetermined region (for example, a predefined position in a store), and a layout regarding an arrangement of a merchandise display shelf or the like in the store is changed.

When a heat map image is generated by superimposing staying information or passing information of a person on an image captured by a camera, if a layout in the store is changed, the staying information or passing information of the person obtained before the layout is changed does not match an image captured by the camera after the layout is changed, and thus an accurate heat map image indicating accurate staying information or passing information cannot be obtained.

For this reason, whenever the layout in the store is changed, the floor plan related to the layout is required to be changed in PTL 1. In addition, in NPL 1, since an image as a base of the heat map image is the image captured by the camera, the person is shown in the image, and thus there is a problem in that the privacy of the person is not appropriately protected. In a large store or the like, a plurality of cameras are frequently required to monitor situations in a store, but, in the configuration disclosed in PTL 1 or NPL 1, it is difficult to obtain a wide heat map image indicating accurate staying information or passing information of a person (for example, a customer) in such a large store or the like.

In order to solve the above-described problems, an object of the present disclosure is to provide a flow line analysis system and a flow line display method capable of displaying a flow line analysis image in which the privacy of a person reflected in a wide imaging region is appropriately protected, and staying information or passing information of a person in the wide imaging region can be easily and accurately recognized.

According to the present disclosure, there is provided a flow line analysis system including a plurality of cameras; and a server that is connected to the cameras, in which each of the cameras captures an image of a differing imaging region, repeatedly generates a background image of a captured image of the imaging region, extracts flow line information regarding a staying position or a passing position of a moving object in the imaging region of the camera, included in the captured image, and transmits the generated background image and the extracted flow line information of the moving object to the server at a predetermined transmission cycle, and in which the server acquires flow line analysis images based on superimposition between the background image of the captured image and the flow line information of the moving object for each camera, generates a wide-region flow line analysis image by using the plurality of acquired flow line analysis images, and displays the generated wide-region flow line analysis image on a display section.

According to the present disclosure, there is provided a flow line display method for a flow line analysis system in which a plurality of cameras are connected to a server, the method including causing each of the cameras to capture an image of a differing imaging region, to repeatedly generate a background image of a captured image of the imaging region, to extract flow line information regarding a staying position or a passing position of a moving object in the imaging region of the camera, included in the captured image, and to transmit the generated background image and the extracted flow line information of the moving object to the server at a predetermined transmission cycle; and causing the server to acquire flow line analysis images based on superimposition between the background image of the captured image and the flow line information of the moving object for each camera, to generate a wide-region flow line analysis image by using the plurality of acquired flow line analysis images, and to display the generated wide-region flow line analysis image on a display section.

According to the present disclosure, it is possible to display a flow line analysis image in which the privacy of a person reflected in a wide imaging region can be appropriately protected, and staying information or passing information of a person in the wide imaging region can be easily and accurately recognized.

### BRIEF DESCRIPTION OF DRAWINGS

FIG. 1 is a system configuration diagram illustrating details of a configuration of a sales management system including a flow line analysis system of the present exemplary embodiment.

FIG. 2 is a block diagram illustrating details of a functional internal configuration of each of a camera and a server of the present exemplary embodiment.

FIG. 3 is a diagram illustrating a summary of an operation of a background image generating section of the camera of the present exemplary embodiment.

FIG. 4A is a diagram illustrating an example of a captured image which is input to an image input section.

FIG. 4B is a diagram illustrating an example of a background image generated by the background image generating section.

FIG. 5 is a time chart illustrating operation timings of respective processes including image input, background image generation, and flow line information analysis in the camera of the present exemplary embodiment.

FIG. 6 is a time chart corresponding to a case where the camera of the present exemplary embodiment periodically performs a transmission process.

FIG. 7 is a time chart corresponding to a case where the camera of the present exemplary embodiment changes an operation timing of the transmission process in response to detection of an event.

FIG. 8 is a time chart corresponding to a case where the camera of the present exemplary embodiment omits the transmission process before and after an event is detected.

FIG. 9 is a diagram illustrating an example of a layout of a food sales area in which the camera of the present exemplary embodiment is provided in a plurality.

FIG. 10 is a diagram illustrating a first example of an operation screen including a flow line analysis image of store A, generated by a display image generating section of the server of the present exemplary embodiment;

FIG. 11 is a diagram illustrating a second example of an operation screen including a flow line analysis image of store A, generated by the display image generating section of the server of the present exemplary embodiment.

FIG. 12 is a diagram illustrating an example of an operation screen of a monthly report related to a food sales area of the store A, dated in May, 2014, generated by a report generating output section of the server of the present exemplary embodiment.

FIG. 13 is a block diagram illustrating details of a functional internal configuration of a camera of a first modification example of the present exemplary embodiment.

FIG. 14 is a block diagram illustrating details of first another example of a functional internal configuration of each of the camera and the server of the present exemplary embodiment.

FIG. 15 is a block diagram illustrating details of second another example of a functional internal configuration of each of the camera and the server of the present exemplary embodiment.

FIG. 16 is a diagram illustrating an example of a layout regarding a merchandise display shelf of a certain wide floor of a store.

FIG. 17 is a schematic diagram illustrating examples of procedures of generating a wide-region flow line analysis image.

FIG. 18A is a flowchart illustrating first examples of operation procedures regarding generation and display of a wide-region flow line analysis image among a plurality of cameras and the server.

FIG. 18B is a flowchart illustrating second examples of operation procedures regarding generation and display of a wide-region flow line analysis image among a plurality of cameras and the server.

FIG. 19A is a flowchart illustrating third examples of operation procedures regarding generation and display of a wide-region flow line analysis image among a plurality of cameras and the server.

FIG. 19B is a flowchart illustrating fourth examples of operation procedures regarding generation and display of a wide-region flow line analysis image among a plurality of cameras and the server.

### DESCRIPTION OF EMBODIMENT

Hereinafter, a description will be made of an exemplary embodiment (hereinafter, referred to as the “present exemplary embodiment”) in which a flow line analysis system and a flow line display method according to the present disclosure are specifically disclosed with reference to the drawings. The present disclosure may be defined as a flow line analysis image generating method including an operation (step) in which a camera generates a flow line analysis image or a wide-region flow line analysis image (which will be described later). However, a detailed description more than necessary will be omitted in some cases. For example, a detailed description of the well-known content or a repeated description of the substantially same configuration will be omitted in some cases. This is so that a person skilled in the art can easily understand the present disclosure by preventing the following description from being unnecessarily redundant. The accompanying drawings and the following description are provided in order for a person skilled in the art to fully understand the present disclosure, and are not intended to limit the subject matter recited in the claims.

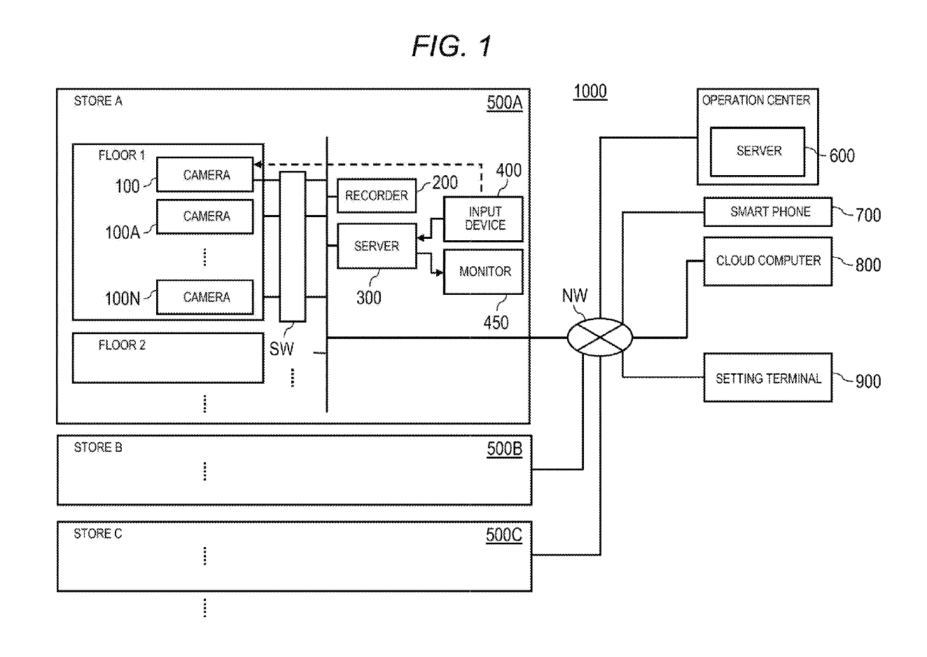

In the following present exemplary embodiment, as illustrated in FIG. 1, a description thereof will be made, for example, assuming use of sales management system 1000 in which flow line analysis systems 500A, 500B, 500C, . . . related to the present disclosure are respectively provided in a plurality of stores (store A, store B, store C, . . . ), and the plurality of flow line analysis systems 500A, 500B, 500C, . . . are connected to each other via network NW. However, exemplary embodiments of the flow line analysis system, a camera, and a flow line analyzing method related to the present disclosure are not limited to content to be described later.

FIG. 1 is a system configuration diagram illustrating details of a configuration of sales management system 1000 including flow line analysis systems 500A, 500B, 500C, . . . of the present exemplary embodiment. Sales management system 1000 illustrated in FIG. 1 includes flow line analysis systems 500A, 500B, 500C, . . . which are respectively provided in a plurality of stores A, B, C, . . . , server 600 of an operation center, smart phone 700, cloud computer 800, and setting terminal 900.

Respective flow line analysis systems 500A, 500B, 500C, . . . , server 600 of the operation center, smart phone 700, cloud computer 800, and setting terminal 900 are connected to each other via network NW. Network NW is wireless network or a wired network. The wireless network is, for example, a wireless local area network (LAN), a wireless wide area network (WAN), 3G, long term evolution (LTE), or wireless gigabit (WiGig). The wired network is, for example, an intranet or the Internet.

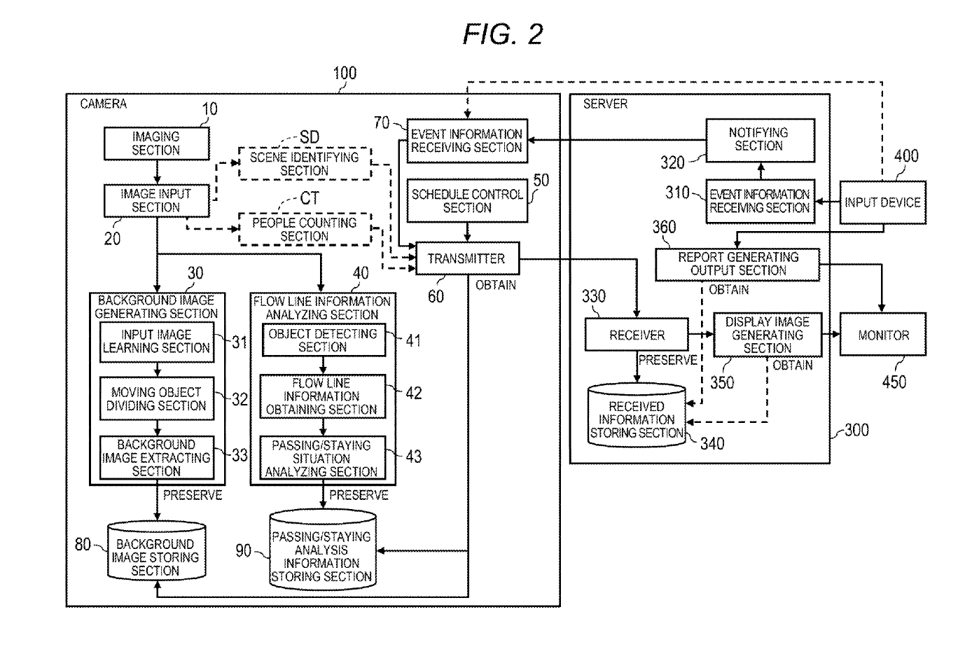

Flow line analysis system 500A provided in store A includes a plurality of cameras 100, 100A, . . . , and 100N provided in floor 1, recorder 200, server 300, input device 400, and monitor 450 illustrated in FIG. 1. The plurality of cameras 100, 100A, . . . , and 100N provided in floor 1, recorder 200, and server 300 are connected to each other via switching hub SW. The switching hub SW relays data which is to be transmitted from cameras 100, 100A, . . . , and 100N to recorder 200 or server 300. The switching hub SW may relay data which is to be transmitted from recorder 200 to server 300. In the same manner as in floor 1, a plurality of cameras and switching hub SW are provided in floor 2, and the cameras and switching hub SW in floor 2 are not illustrated. Internal configurations of respective cameras 100, 100A, . . . , and 100N are the same as each other, and details thereof will be described later with reference to FIG. 2.

Recorder 200 is configured by using, for example, a semiconductor memory or a hard disk device, and stores data on an image captured by each of the cameras provided in store A (hereinafter, the image captured by the camera is referred to as a “captured image”). The data on the captured image stored in recorder 200 is provided for monitoring work such as crime prevention.

Server 300 is configured by using, for example, a personal computer (PC), and notifies camera 100 of the occurrence of a predetermined event (for example, a change of a layout of a sales area of floor 1 of store A) in response to an input operation performed by a user (who is a user of, for example, the flow line analysis system and indicates a salesperson or a store manager of store A; this is also the same for the following description) who operates input device 400.

Server 300 generates a flow line analysis image in which flow line information regarding a staying position or a passing position of a moving object (for example, a person such as a salesperson, a store manager, or a store visitor; this is also the same for the following description) in an imaging region of the camera (for example, camera 100) is superimposed on a captured image obtained by the camera (for example, camera 100) by using data (which will be described later) transmitted from the camera (for example, camera 100), and displays the image on monitor 450.

Server 300 performs a predetermined process (for example, a process of generating a flow line analysis report which will be described later) in response to an input operation performed by the user operating input device 400, and displays the flow line analysis report on monitor 450. Details of an internal configuration of server 300 will be described later with reference to FIG. 2.

Input device 400 is configured by using, for example, a mouse, a keyboard, a touch panel, or a touch pad, and outputs a signal corresponding to a user's input operation to camera 100 or server 300. In FIG. 1, for simplification of illustration, an arrow is shown only between input device 400 and camera 100, but arrows may be shown between input device 400 and other cameras (for example, cameras 100A and 100N).

Monitor 450 is configured by using, for example, a liquid crystal display (LCD) or an organic electroluminescence (EL) display, and displays data related to a flow line analysis image or a flow line analysis report generated by server 300. Monitor 450 is provided as an external apparatus separately from server 300, but may be included in server 300.

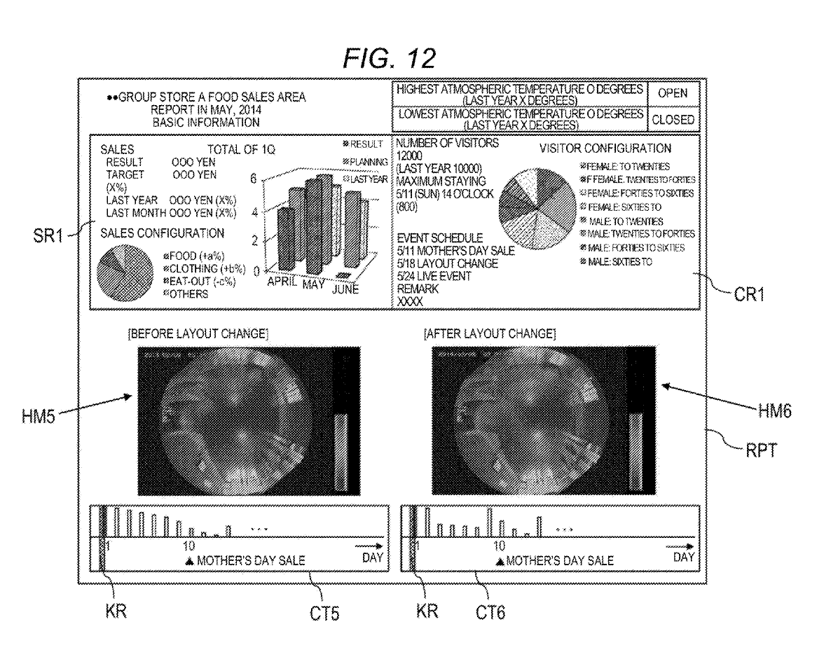

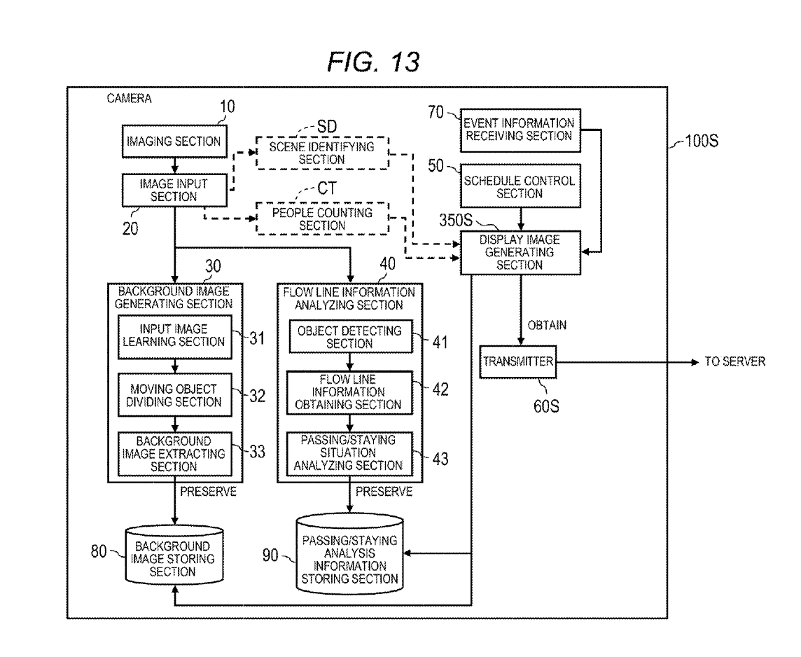

Server 600 of the operation center is a viewing apparatus which acquires and displays flow line analysis images or flow line analysis reports generated by flow line analysis systems 500A, 500B, 500C, . . . provided in the respective stores A, B, C, . . . in response to an input operation performed by an employee (for example, an officer) of the operation center who operates server 600 of the operation center. Server 600 of the operation center holds various information pieces (for example, sales information, information regarding the number of visitors, event schedule information, the highest atmospheric temperature information, and the lowest atmospheric temperature information) required to generate a flow line analysis report (refer to FIG. 12). These various information pieces may be held in the servers provided in respective stores A, B, C, . . . . Server 600 of the operation center may perform each process which is performed by the server (for example, server 300 of store A) provided in each of stores A, B, C, . . . . Consequently, server 600 of the operation center can integrate data from the respective stores A, B, C, . . . so as to generate a flow line analysis report (for example, refer to FIG. 12 to be described later) and thus to acquire specific data (for example, a flow line analysis report illustrated in FIG. 12) related to one store selected through an input operation on server 600 of the operation center, or to display a data comparison result between specific sales areas (for example, meat sales areas) of a plurality of stores.

Smart phone 700 is a viewing apparatus which acquires and displays flow line analysis images or flow line analysis reports generated by flow line analysis systems 500A, 500B, 500C, . . . provided in the respective stores A, B, C, . . . in response to an input operation performed by an employee (for example, a sales representative) of the operation center who operates smart phone 700.

The cloud computer 800 is an online storage which stores data related to flow line analysis images or flow line analysis reports generated by flow line analysis systems 500A, 500B, 500C, . . . provided in the respective stores A, B, C, . . . , and performs a predetermined process (for example, retrieval and extraction of a flow line analysis report dated on the Y-th day of the X month) in response to an input operation performed by an employee (for example, a sales representative) of the operation center who operates smart phone 700 and transmits a process result on smart phone 700.

Setting terminal 900 is configured by using, for example, a PC, and can execute dedicated browser software for displaying a setting screen of the camera of flow line analysis systems 500A, 500B, 500C, . . . provided in the respective stores A, B, C, . . . . Setting terminal 900 displays a setting screen (for example, a common gateway interface (CGI)) of the camera by using the browser software in response to an input operation of an employee (for example, a system manager of sales management system 1000) of the operation center operating setting terminal 900, and sets information regarding the camera by editing (correcting, adding, and deleting) the information.

### Camera

FIG. 2 is a block diagram illustrating details of a functional internal configuration of each of camera 100 and server 300 of the present exemplary embodiment. In sales management system 1000 illustrated in FIG. 1, the cameras provided in the respective stores A, B, C, . . . have the same configuration, and thus camera 100 will be described as an example in FIG. 2.

Camera 100 illustrated in FIG. 2 includes imaging section 10, image input section 20, background image generating section 30, flow line information analyzing section 40, schedule control section 50, transmitter 60, event information receiving section 70, background image storing section 80, and passing/staying analysis information storing section 90. Background image generating section 30 includes input image learning section 31, moving object dividing section 32, and background image extracting section 33. Flow line information analyzing section 40 includes object detecting section 41, flow line information obtaining section 42, and passing/staying situation analyzing section 43.

Imaging section 10 includes at least a lens and an image sensor. The lens collects light (light beams) which is incident from the outside of camera 100 and forms an image on a predetermined imaging surface of the image sensor. As the lens, a fish-eye lens, or a wide angle lens which can obtain an angle of view of 140 degrees or greater is used. The image sensor is a solid-state imaging element such as a charged-coupled device (CCD) or a complementary metal oxide semiconductor (CMOS), and converts an optical image formed on the imaging surface into an electric signal.

Image input section 20 is configured by using, for example, a central processing unit (CPU), a micro-processing unit (MPU), or a digital signal processor (DSP), and performs a predetermined signal process using the electric signal from imaging section 10 so as to generate data (frame) for a captured image defined by red, green, and blue (RGB) or YUV (luminance and color difference) which can be recognized by the human eye, and outputs the data to background image generating section 30 and flow line information analyzing section 40.

Background image generating section 30 is configured by using, for example, a CPU, an MPU, or a DSP, and generates a background image obtained by removing a moving object (for example, a person) included in the captured image for every data item (frame) for the captured image output from image input section 20 at a predetermined frame rate (for example, 30 frames per second (fps)), and preserves the background image in background image storing section 80. The process of generating a background image in background image generating section 30 may employ an image processing method disclosed in the following Patent Literature but is not limited to this method.
(Reference Patent Literature) Japanese Patent Unexamined Publication No. 2012-203680

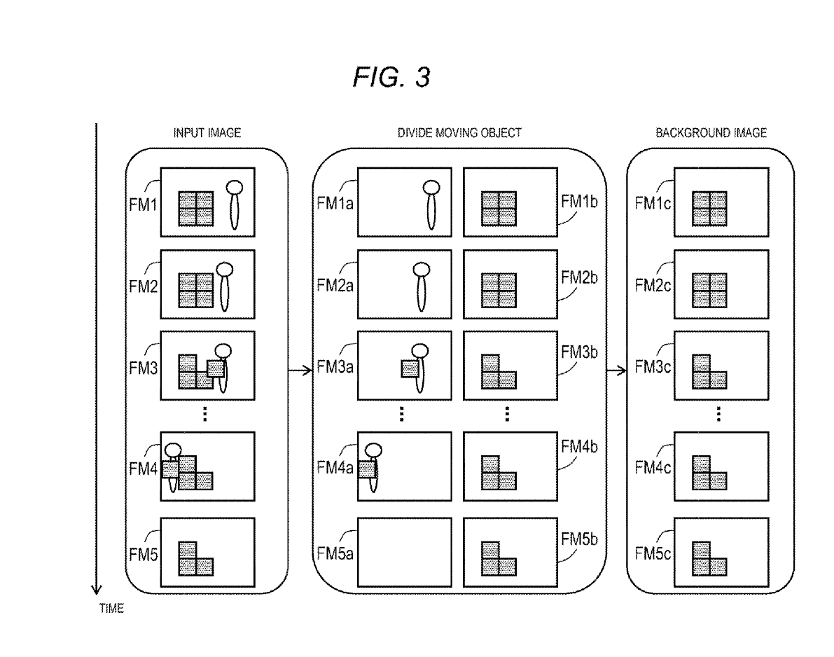

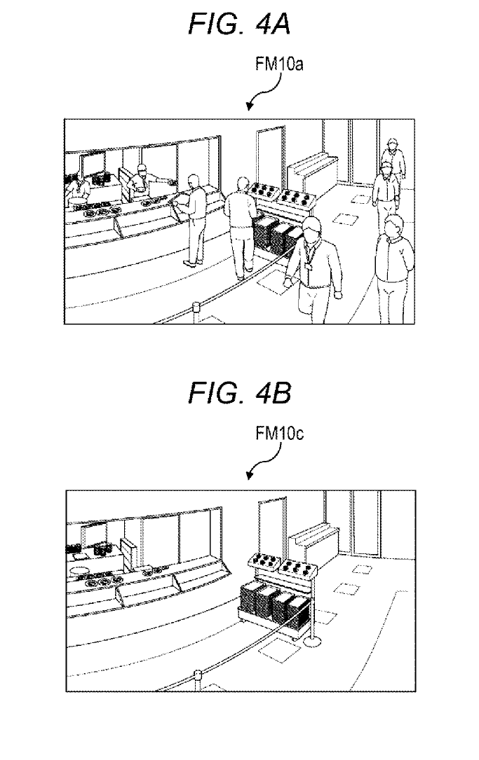

Here, a summary of an operation of background image generating section 30 will be described briefly with reference to FIGS. 3 to 4B. FIG. 3 is a diagram illustrating a summary of an operation of background image generating section 30 of camera 100 according to the present exemplary embodiment. FIG. 4A is a diagram illustrating an example of a captured image which is input to image input section 20. FIG. 4B is a diagram illustrating an example of a background image generated by background image generating section 30.

FIG. 3 schematically illustrates results generated by input image learning section 31, moving object dividing section 32, and background image extracting section 33 from the left side to the right side of the figure perpendicular to a time axis which is directed from the top to the bottom of the figure, and illustrates a state in which a visitor to the store carries one corrugated cardboard among four corrugated cardboards for drinks.

Input image learning section 31 analyzes a distribution situation of values of luminance and color difference in each pixel in frames (for example, respective frames FM1 to FM5 illustrated in FIG. 3) of a plurality of captured images output from image input section 20.

Moving object dividing section 32 divides the respective frames FM1 to FM5 of the captured images into information (for example, refer to frames FM1a to FM5a) regarding a moving object (for example, a person) and information (for example, refer to frames FM1b to FM5b) regarding a portion (for example, a background) other than the moving object, by using a learning result (that is, an analysis result of the distribution situation of the luminance and the color difference in each pixel of the plurality of frames (for example, in the time axis direction illustrated in FIG. 3)) of input image learning section 31. In the frames FM3 and FM4 of the captured images showing a state in which the person as a moving object carries the corrugated cardboard, values of luminance and color differences corresponding to pixels of the corrugated cardboard carried by the person change in the time axis direction (for example, refer to FIG. 3), and thus moving object dividing section 32 regards the corrugated cardboard carried by the person as a moving object.

Background image extracting section 33 extracts frames FM1b to FM5b in which the information regarding the portion other than the moving object is shown among the information pieces divided by moving object dividing section 32, as frames FM1c to FM5c for background images corresponding to frames FM1 to FM5 of the captured images output from image input section 20, and preserves the frames in background image storing section 80.

In frame FM10a of a captured image illustrated in FIG. 4A, for example, a person providing food and a person receiving the food on a tray in a restaurant are shown as moving objects. In contrast with frame FM10a of the captured image illustrated in FIG. 4A, in frame FM10c (refer to FIG. 4B) of a background image generated by background image generating section 30, the person providing the food and the person receiving the food as moving objects in the same restaurant are removed so that neither of the two persons are shown.

Flow line information analyzing section 40 is configured by using, for example, a CPU, an MPU, or a DSP, and detects flow line information regarding a staying position or a passing position of a moving object (for example, a person) included in the captured image for every data item (frame) regarding the captured image output from image input section 20 at a predetermined frame rate (for example, 10 fps), and preserves the background image in passing/staying analysis information storing section 90.

Object detecting section 41 performs a predetermined image process (for example, a person detection process or a face detection process) on a frame of a captured image output from image input section 20 so as to detect the presence or absence of a moving object (for example, a person) included in the frame of the captured image. In a case where a moving object included in the frame of the captured image is detected, object detecting section 41 outputs information (for example, frame coordinate information) regarding a detection region of the moving object in the frame of the captured image, to flow line information obtaining section 42. In a case where a moving object included in the frame of the captured image is not detected, object detecting section 41 outputs information (for example, predetermined null information) regarding a detection region of the moving object, to flow line information obtaining section 42.

Flow line information obtaining section 42 associates the present and past information pieces regarding the detection region with each other by using the information regarding the captured image output from image input section 20 and the past information (for example, captured image information or coordinate information) regarding the detection region of the moving object on the basis of the information regarding the detection region of the moving object output from object detecting section 41, and outputs the association result to passing/staying situation analyzing section 43 as flow line information (for example, an amount of change in the coordinate information of the detection region of the moving object).

Passing/staying situation analyzing section 43 extracts and generates, from a plurality of captured images, flow line information (for example, “object position information”, “flow line information”, and “information regarding a passing situation or a staying situation”) regarding a staying position or a passing position of the moving object (for example, a person) in the frame of the captured image on the basis of the flow line information output from flow line information obtaining section 42. Passing/staying situation analyzing section 43 may generate a color portion visualizing image of a flow line analysis image (heat map image) generated in display image generating section 350 of server 300 by using the extraction result of the flow line information regarding the staying position or the passing position of the moving object (for example, a person).

By using flow line information for frames of a plurality of captured images, passing/staying situation analyzing section 43 can extract and generate accurate flow line information regarding a position where a moving object (for example, a person) stays or passes from the frames of the captured images which are output from image input section 20.

Schedule control section 50 is configured by using, for example, a CPU, an MPU, or a DSP, and gives, to transmitter 60, an instruction for a predetermined transmission cycle for periodically transmitting, to server 300, the background image data preserved in background image storing section 80 and the extraction result data of the flow line information regarding the staying information or the passing information of the moving object preserved in passing/staying analysis information storing section 90. The predetermined transmission cycle is, for example, 15 minutes, an hour, 12 hours, or 24 hours, and is not limited to such intervals.

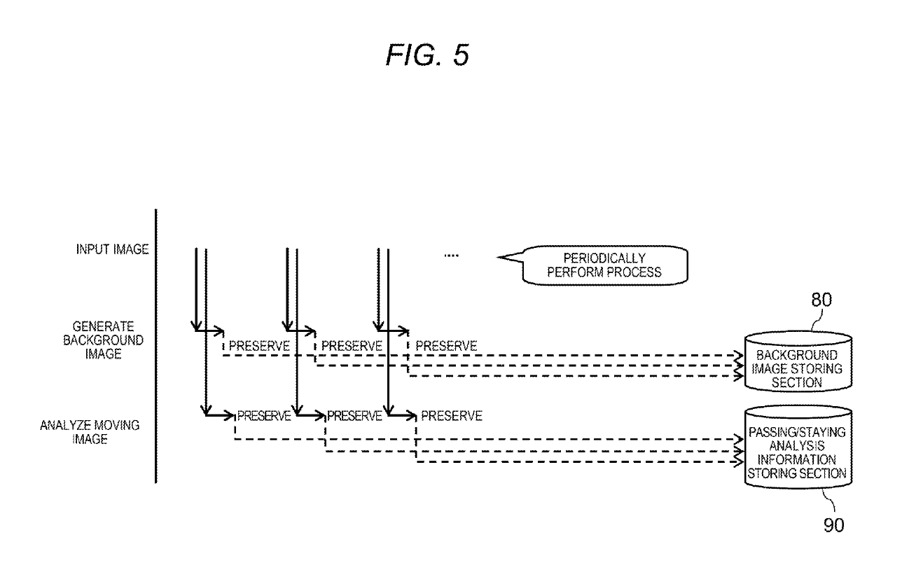

Transmitter 60 obtains and transmits the background image data preserved in background image storing section 80 and the extraction result data of the flow line information regarding the staying information or the passing information of the moving object preserved in passing/staying analysis information storing section 90 to server 300 in response to the instruction from schedule control section 50 or event information receiving section 70. Transmission timing in transmitter 60 will be described later with reference to FIGS. 5 to 8.

Event information receiving section 70 as an example of an event information obtaining section receives (obtains) a notification of detection of a predetermined event (for example, a change of a layout of a sales area of floor 1 of store A) from server 300 or input device 400, and outputs, to transmitter 60, an instruction for transmitting, to server 300, the background image data preserved in background image storing section 80 and the extraction result data of the flow line information regarding the staying information or the passing information of the moving object preserved in passing/staying analysis information storing section 90 when receiving the notification of detection of the predetermined event.

Background image storing section 80 is configured by using, for example, a semiconductor memory or a hard disk device, and stores the data (frame) regarding the background image generated by background image generating section 30.

Passing/staying analysis information storing section 90 is configured by using, for example, a semiconductor memory or a hard disk device, and stores the extraction result data (for example, “object position information”, “flow line information”, and “information regarding a passing situation or a staying situation”) of the flow line information regarding the staying position or the passing position of the moving object (for example, a person), generated by flow line information analyzing section 40.

Camera 100 illustrated in FIG. 2 may be provided with scene identifying section SD which performs an operation as follows (for example, refer to FIG. 13) instead of event information receiving section 70. Scene identifying section SD as an example of an image change detecting section detects whether or not there is a change (for example, an event such as a change of a layout of a sales area of floor 1 of store A) in a captured image output from image input section 20. In a case where a change in the captured image is detected, scene identifying section SD outputs, to transmitter 60, an instruction for transmitting, to server 300, the background image data preserved in background image storing section 80 and the extraction result data of the flow line information regarding the staying information or the passing information of the moving object preserved in passing/staying analysis information storing section 90.

Camera 100 illustrated in FIG. 2 may be further provided with people counting section CT which performs an operation as follows (for example, refer to FIG. 13). People counting section CT as an example of a moving object detecting section performs a predetermined image process (for example, a person detecting process) on a captured image output from image input section 20 so as to count the number of detected moving objects included in the captured image. People counting section CT outputs information regarding the number of detected moving objects included in the captured image to transmitter 60.

### Server

Server 300 illustrated in FIG. 2 includes event information receiving section 310, notifying section 320, receiver 330, received information storing section 340, display image generating section 350, and report generating output section 360.

In a case where information indicating that a predetermined event (for example, a change of a layout of a sales area of floor 1 of store A) has occurred for each corresponding camera (for example, camera 100) is input from input device 400, event information receiving section 310 receives a notification of detection of the predetermined event. Event information receiving section 310 outputs information indicating that the notification of detection of the predetermined event has been received, to notifying section 320. The information indicating that a predetermined event has occurred includes an identification number (for example, C1, C2, . . . which will be described later) of the camera which images a location where the predetermined event has occurred as an imaging region.

Notifying section 320 transmits the notification of detection of the predetermined event, output from event information receiving section 310, to a corresponding camera (for example, camera 100).

Receiver 330 receives the data (that is, the background image data preserved in background image storing section 80 and the extraction result data of the flow line information regarding the staying information or the passing information of the moving object preserved in passing/staying analysis information storing section 90) transmitted from transmitter 60 of camera 100, and outputs the data to received information storing section 340 and display image generating section 350.

Received information storing section 340 is configured by using, for example, a semiconductor memory or a hard disk device, and stores the data (that is, the background image data preserved in background image storing section 80 and the extraction result data of the flow line information regarding the staying information or the passing information of the moving object preserved in passing/staying analysis information storing section 90) received by receiver 330.

Display image generating section 350 as an example of an image generating section is configured by using, for example, a CPU, an MPU, or a DSP, and generates a flow line analysis image in which the flow line information regarding the staying position and the passing position of the moving object is superimposed on the background image by using the data (that is, the background image data preserved in background image storing section 80 and the extraction result data of the flow line information regarding the staying information or the passing information of the moving object preserved in passing/staying analysis information storing section 90) is obtained from receiver 330 or received information storing section 340.

The flow line analysis image is an image in which the flow line information visually indicating a location at which a moving object stays or a location through which the moving object passes is quantitatively visualized within a predetermined range (for example, values of 0 to 255) such as in a heat map in an imaging region corresponding to a captured image on the background image obtained by removing the moving object (for example, a person) which thus is not shown from the captured image acquired by camera 100. Display image generating section 350 as an example of a display control section displays the generated flow line analysis image on monitor 450.

Report generating output section 360 as an example of a report generating section is configured by using, for example, a CPU, an MPU, or a DSP, and generates a flow line analysis report (for example, refer to FIG. 12) which will be described later in a case where an instruction for generating the flow line analysis report is input from input device 400. Report generating output section 360 as an example of a display control section displays the generated flow line analysis report on monitor 450.

### Process of Transmitting Data from Camera to Server

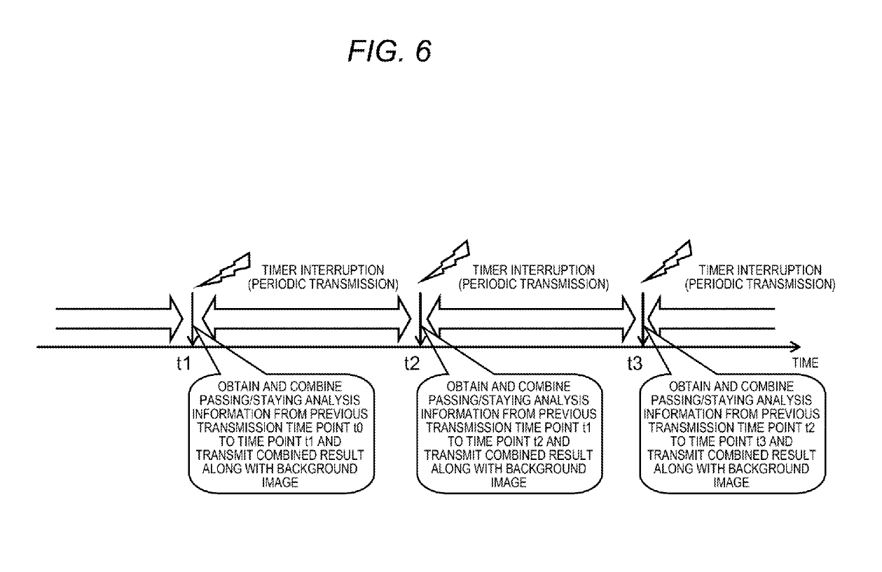

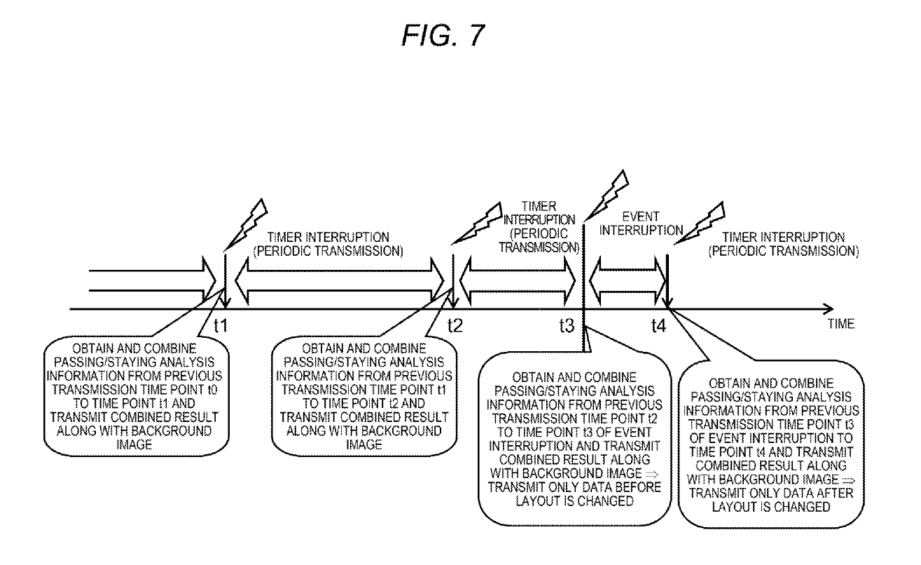

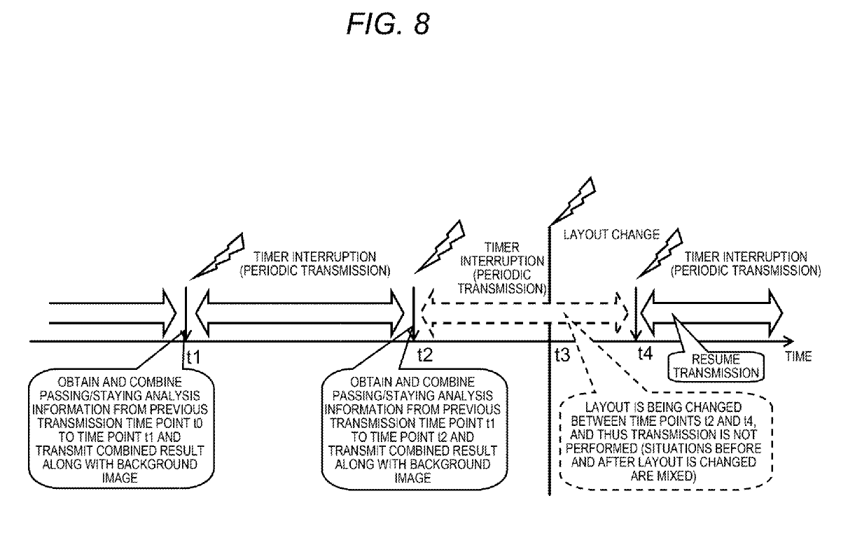

Next, with reference to FIGS. 5 to 8, a description will be made of a process of transmitting data from camera 100 to server 300. FIG. 5 is a time chart illustrating operation timings of a transmission process in camera 100 of the present exemplary embodiment. FIG. 6 is a time chart corresponding to a case where camera 100 of the present exemplary embodiment periodically performs the transmission process. FIG. 7 is a time chart corresponding to a case where camera 100 of the present exemplary embodiment changes an operation timing of the transmission process in response to detection of an event. FIG. 8 is a time chart corresponding to a case where camera 100 of the present exemplary embodiment omits the transmission process before and after an event is detected.

In FIG. 5, in camera 100, if a captured image is output from image input section 20 (image input), background image generating section 30 generates a background image of the captured image output from image input section 20 (background image generation) and preserves the background image in background image storing section 80, and flow line information analyzing section 40 extracts flow line information regarding a staying position or a passing position of a moving object (for example, a person) included in the captured image output from image input section 20 (flow line information analysis). The respective processes such as the image input, the background image generation, and the flow line information analysis are periodically and repeatedly performed.

For example, after the initial respective processes such as the image input, the background image generation, and the flow line information analysis illustrated in FIG. 5 are performed, for example, as illustrated in FIG. 7, at an end point of a transmission cycle for which an instruction is given by schedule control section 50, transmitter 60 receives, for example, timer interruption from schedule control section 50, obtains the background image data preserved in background image storing section 80 and the extraction result data of the flow line information regarding the staying information or the passing information of the moving object preserved in passing/staying analysis information storing section 90 from previous transmission time point t0 to present transmission time point t1, and transmits the data to server 300 (time point t1). As described above, a periodic transmission interval (transmission cycle) in transmitter 60 is 15 minutes, an hour, 12 hours, 24 hours, or the like, and an instruction therefor is given by schedule control section 50 in advance. The background image data transmitted by transmitter 60 may be data corresponding to a single background image or may be data corresponding to a plurality of background images (for example, a plurality of background images obtained at intervals of five minutes).

Next, when the second and subsequent respective processes such as the inputting of the image input, the background image generation, and the flow line information analysis illustrated in FIG. 5 are performed, for example, as illustrated in FIG. 7, at an end point of a transmission cycle for which an instruction is given by schedule control section 50, transmitter 60 receives, for example, timer interruption from schedule control section 50, obtains the background image data preserved in background image storing section 80 and the extraction result data of the flow line information regarding the staying information or the passing information of the moving object preserved in passing/staying analysis information storing section 90 from previous transmission time point t1 to present transmission time point t2, and transmits the data to server 300 (time point t2).

For example, as illustrated in FIG. 7, if a notification of detection of a predetermined event (for example, a change of a layout of a sales area of floor 1 of store A) is received from event information receiving section 70 (time point t3), transmitter 60 receives, for example, event interruption from event information receiving section 70, obtains the background image data preserved in background image storing section 80 and the extraction result data of the flow line information regarding the staying information or the passing information of the moving object preserved in passing/staying analysis information storing section 90 from previous transmission time point t2 to present transmission time point t3, and transmits the data to server 300 (time point t3). A transmission process in transmitter 60 may be performed by using not only the method illustrated in FIG. 7 but also either of the methods illustrated in FIGS. 6 and 8.

In FIGS. 6 to 8, description of the same content as that of the transmission process illustrated in FIG. 5 will be made briefly or omitted, and different content will be described. Specifically, in FIG. 6, even if event interruption is received from event information receiving section 70 at time point t3, transmitter 60 does not transmit the background image data preserved in background image storing section 80 and the extraction result data of the flow line information regarding the staying information or the passing information of the moving object preserved in passing/staying analysis information storing section 90 from previous transmission time point t2 to present transmission time point t3 to server 300 (time point t3).

However, in the transmission process illustrated in FIG. 6, in a case where a predetermined event occurs from time point t2 to time point t3, since content of a captured image is updated, different background images are used together before and after the event is detected, and thus there is a possibility that the content of a flow line analysis image may not be accurate.

Therefore, in FIG. 7, if a notification of detection of a predetermined event (for example, a change of a layout of a sales area of floor 1 of store A) from event information receiving section 70 (time point t3), transmitter 60 receives, for example, event interruption from event information receiving section 70, obtains the background image data preserved in background image storing section 80 and the extraction result data of the flow line information regarding the staying information or the passing information of the moving object preserved in passing/staying analysis information storing section 90 from previous transmission time point t2 to present transmission time point t3 at which the event interruption is received, and transmits the data to server 300 (time point t3). At an end point of a transmission cycle for which an instruction is given by schedule control section 50, transmitter 60 receives, for example, timer interruption from schedule control section 50, obtains the background image data preserved in background image storing section 80 and the extraction result data of the flow line information regarding the staying information or the passing information of the moving object preserved in passing/staying analysis information storing section 90 from previous transmission time point t3 at which the event interruption is received to present transmission time point t4, and transmits the data to server 300 (time point t4).

In FIG. 8, even if event interruption is received from event information receiving section 70 at time point t3, transmitter 60 does not transmit the background image data preserved in background image storing section 80 and the extraction result data of the flow line information regarding the staying information or the passing information of the moving object preserved in passing/staying analysis information storing section 90 from previous transmission time point t2 to present transmission time point t3 at which the event interruption is received to server 300 (time point t3). At an end point of a transmission cycle for which an instruction is given by schedule control section 50, transmitter 60 receives, for example, timer interruption from schedule control section 50, and does not transmit the background image data preserved in background image storing section 80 and the extraction result data of the flow line information regarding the staying information or the passing information of the moving object preserved in passing/staying analysis information storing section 90 from previous transmission time point t3 at which the event interruption is received to present transmission time point t4, and transmits the data to server 300 (time point t4).

In other words, in a case where the event interruption is received from event information receiving section 70 at time point t3, transmitter 60 does not transmit the background image data preserved in background image storing section 80 and the extraction result data of the flow line information regarding the staying information or the passing information of the moving object preserved in passing/staying analysis information storing section 90 from previous transmission time point t2 up to a start point (t4 in FIG. 8) of a transmission cycle after the event interruption is received, to server 300 (from time point t2 to time point t4).

In FIG. 8, for example, if timer interruption is received from schedule control section 50 (time point t4), transmitter 60 resumes transmission of the background image data preserved in background image storing section 80 and the extraction result data of the flow line information regarding the staying information or the passing information of the moving object preserved in passing/staying analysis information storing section 90 to server 300. Specifically, although not illustrated in FIG. 8, at an end point of a transmission cycle for which an instruction is given by schedule control section 50 after time point t4, transmitter 60 receives, for example, timer interruption from schedule control section 50, obtains the background image data preserved in background image storing section 80 and the extraction result data of the flow line information regarding the staying information or the passing information of the moving object preserved in passing/staying analysis information storing section 90 from time point t4 to the present transmission time point, and transmits the data to server 300.

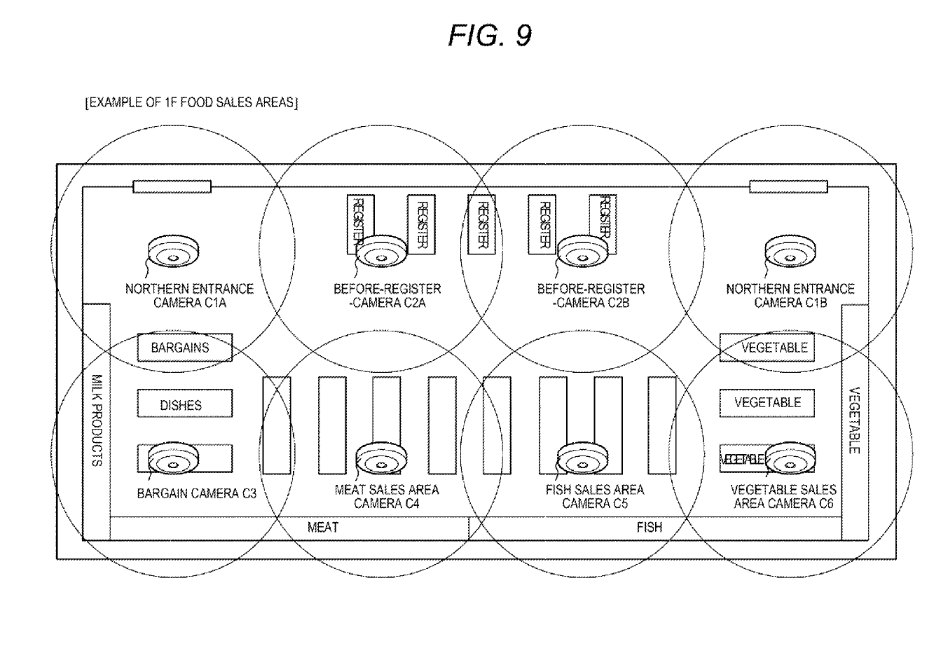

FIG. 9 is a diagram illustrating an example of a layout of a food sales area where camera 100 of the present exemplary embodiment is provided in plurality. FIG. 9 illustrates a state in which, for example, in the food sales area of floor 1 (1F) of store A, a plurality of (for example, eight) cameras are provided on a ceiling surface of floor 1. Specifically, a total of eight cameras (for example, omnidirectional cameras) including northern entrance cameras C1A and C1B, before-register-cameras C2A and C2B, bargain camera C3, meat sales area camera C4, fish sales area camera C5, and vegetable sales area camera C6 are provided. The type of camera is not limited to the omnidirectional camera, and may be a fixed camera in which a fixed angle of view is set, or may be a PTZ (pan, tilt, and zoom) camera having a panning function, a tilting function, and a zooming function.

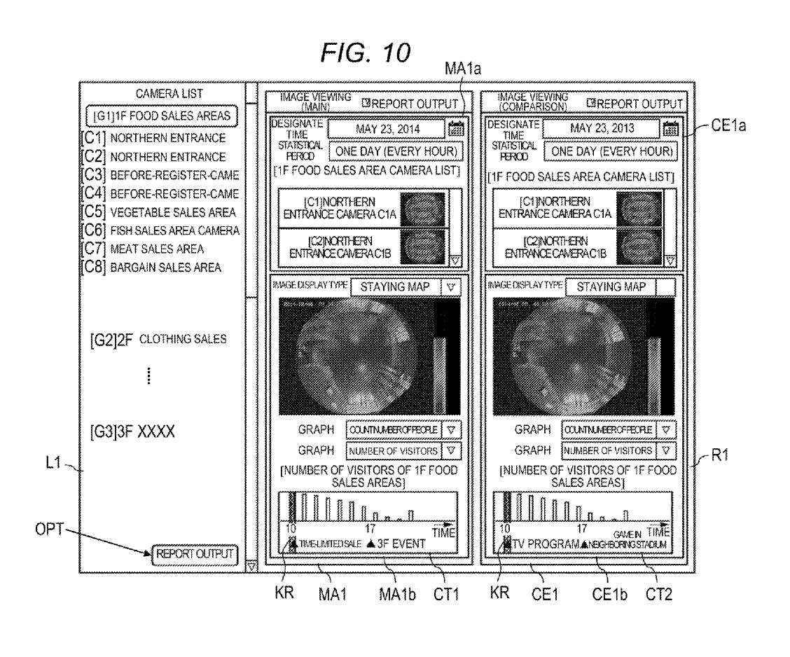

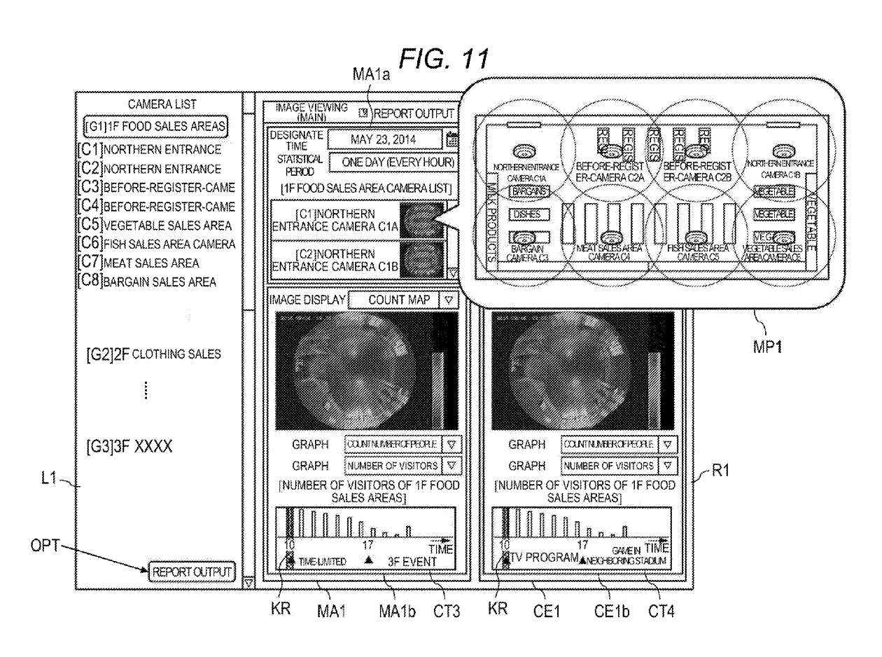

FIG. 10 is a diagram illustrating a first example of an operation screen including a flow line analysis image of store A, generated by display image generating section 350 of server 300 of the present exemplary embodiment. FIG. 11 is a diagram illustrating a second example of an operation screen including a flow line analysis image of store A, generated by display image generating section 350 of server 300 of the present exemplary embodiment. The operation screens illustrated in FIGS. 10 and 11 are displayed on monitor 450 by display image generating section 350.

On the operation screen illustrated in FIG. 10, a list of screens for selecting the cameras provided in the store is hierarchically shown in left display region L1. For example, in the food sales area (identification number: G1) of floor 1 (1F), northern entrance camera C1A (identification number: C1), northern entrance camera C1B (identification number: C2), before-register-camera C2A (identification number: C3), before-register-camera C2B (identification number: C4), vegetable sales area camera C6 (identification number: C5), fish sales area camera C5 (identification number: C6), meat sales area camera C4 (identification number: C7), and bargain camera C3 (identification number: C8) are shown hierarchically. This is also the same for a clothing sales area of floor 2 (2F) and other sales areas, and thus description thereof will be omitted.

On the operation screen illustrated in FIG. 10, display region MA1 of main (for example, present) flow line analysis information and display region CE1 of subsidiary (for example, comparison) flow line analysis information are displayed in right display region R1.

In display region MA1 of flow line analysis information, a designated condition display region MA1a including a designated time (including the date) at which server 300 generates a viewing object flow line analysis image, a statistical period indicating, for example, the unit of half a day, the unit of a day, the unit of one week, or the unit of one month, and a screen for selecting the cameras of each sales area selected in display region L1, and flow line analysis result display region MA1b including an image display type of a flow line analysis image, a graph display type, a graph display G (group), and display region CT1 of the number of visitors of each sales area, are displayed.

The image display type of a flow line analysis image includes a staying map, illustrated in FIG. 10, in which staying information of a moving object (for example, a person) is shown, a count map, illustrated in FIG. 11, in which passing information of a moving object (for example, a person) is shown, and captured images thereof. The number of moving objects (for example, persons) detected by people counting section CT in time series (for example, every hour in FIGS. 10 and 11) is shown in display region CT1 of the number of visitors of each sales area. For example, if input device 400 shifts selection bar KR displayed in display region CT1 of the number of visitors of each sales area in the time axis direction through a user's input operation, display image generating section 350 sequentially displays flow line analysis images which are generated at time points indicated by selection bar KR.

As illustrated in FIG. 11, instead of the screen for selecting the cameras of each sales area in display region MA1 of flow line analysis information, an example of layout MP1 in which the plurality of cameras illustrated in FIG. 9 are provided in each sales area may be displayed.

Similarly, on display screen CE1 of subsidiary flow line analysis information, a designated condition display screen CE1a including a designated time (including the date) at which server 300 generates a viewing object flow line analysis image as display screen MA1 of main flow line analysis information, a statistical period indicating, for example, the unit of half a day, the unit of a day, the unit of one week, or the unit of one month, and a screen for selecting the cameras of each sales area selected in display region MA1 of main flow line analysis information, and flow line analysis result display region CE1b including an image display type of a flow line analysis image, a graph display type, a graph display G (group), and display region CT2 of the number of visitors of each sales area, are displayed. In a case of using display screen CE1 of subsidiary flow line analysis information, for example, not only comparison between states before and after a layout in the store is changed but also usage such as comparison between states before and after a discount seal is attached to merchandise, comparison between states before and after a time-limited sale is performed, comparison between a date and the same date in the previous year, and comparison between stores (for example, and comparison between a meat sales area of store A and a meat sales area of the store B) may be included.

The number of moving objects (for example, persons) detected by people counting section CT in a time series (for example, every hour in FIGS. 10 and 11) is shown in display region CT2 of the number of visitors of each sales area. For example, if input device 400 shifts selection bar KR displayed in display region CT2 of the number of visitors of each sales area in the time axis direction through a user's input operation, display image generating section 350 sequentially reproduces and displays flow line analysis images which are generated at time points indicated by selection bar KR.

Input device 400 can designate a specific time zone on the time axis and can input a comment (for example, a time-limited sale, a 3F event, a TV program, and a game in a neighboring stadium), through a user's input operation, to display region CT1 of the number of visitors of each sales area of display region MA1 of main (for example, present) flow line analysis information and display region CT2 of the number of visitors of each sales area of display region CE1 of subsidiary (for example, comparison) flow line analysis information.

In FIG. 11, the remaining content is the same as that described with reference to FIG. 10 except that the image display type is a count map, and thus detailed description thereof will be omitted. In the same manner as in FIG. 10, also in FIG. 11, for example, if input device 400 shifts selection bar KR displayed in each of display regions CT3 and CT4 of the number of visitors of each sales area in the time axis direction through a user's input operation, display image generating section 350 sequentially reproduces and displays flow line analysis images which are generated at time points indicated by selection bar KR.

FIG. 12 is a diagram illustrating an example of operation screen RPT of a monthly report related to a food sales area of store A, dated in May, 2014, generated by report generating output section 360 of server 300 of the present exemplary embodiment. The monthly report (refer to FIG. 12) as an example of a flow line analysis report of the present exemplary embodiment is a screen which is generated by report generating output section 360 and is displayed on monitor 450 when report output button OPT provided on the lower part of left display region L1 of the operation screen illustrated in FIG. 10 or FIG. 11 is pressed via input device 400. Report generating output section 360 of server 300 may output the monthly report illustrated in FIG. 12 or partial information thereof (for example, a monthly report of a meat sales area among the food sales areas) from a printer (not illustrated) provided in store A. Consequently, a salesperson in store A can receive the printed and distributed monthly report of, for example, all the food sales areas or the meat sales area as a part thereof, in the form of a flow line analysis image in which a visitor is not shown being output.

The operation screen RPT of the monthly report (the flow line analysis report) illustrated in FIG. 12 shows various information pieces including a title of the monthly report, information regarding an atmospheric temperature, display region SR1 related to sales information, display region CR1 related to statistical information such as the number of visitors of a store (for example, store A), display regions of flow line analysis images HM5 and HM6 generated by display image generating section 350 before and after a layout of the sales area is changed as an example of a predetermined event, and display regions CT5 and CT6 of the number of visitors of each sales area. The various information pieces regarding the title of the monthly report, the information regarding the atmospheric temperature, the sales information, the event information, the information regarding a configuration of the visitors, and the like are transmitted, for example, from server 600 of the operation center to a server (for example, server 300) of a corresponding store (for example, store A). The various information pieces regarding the title of the monthly report, the information regarding the atmospheric temperature, the sales information, the event information, the information regarding a configuration of the visitors, and the like may be stored in server 300 or a storing section (not illustrated) of the store in advance.

Also in the operation screen RPT of the monthly report illustrated in FIG. 12, in the same manner as in FIG. 10 or FIG. 11, for example, if input device 400 shifts selection bar KR displayed in each of display regions CT5 and CT6 of the number of visitors of each sales area in the time axis direction through a user's input operation, display image generating section 350 sequentially displays flow line analysis images which are generated at time points indicated by selection bar KR.

As mentioned above, in flow line analysis system 500A of the present exemplary embodiment, camera 100 generates a background image of a captured image of a predetermined imaging region, extracts flow line information regarding a staying position or a passing position in the imaging region of a moving object (for example, a person) included in the captured image, and transmits the background image of the captured image and the flow line information of the moving object to server 300 at a predetermined transmission cycle. Server 300 generates a flow line analysis image in which the flow line information of the moving object is superimposed on the background image of the captured image, and displays the flow line analysis image on monitor 450.

Consequently, flow line analysis system 500A generates the background image which is a base of the flow line analysis image so that the moving object (for example, a person) is removed so as not to be shown therein, and can thus appropriately protect the privacy of the moving object (the person) shown in an imaging region when a flow line analysis image is generated. Since flow line analysis system 500A superimposes the flow line information regarding the staying position or the passing position in the imaging region of the moving object (the person) on the background image which has already been updated at a predetermined timing (for example, the time at which a periodic transmission cycle arrives), it is possible to visually display a flow line analysis image which appropriately indicates accurate flow line information regarding the staying position or the passing position in the imaging region of the moving object to a user in a predefined transmission cycle in a state in which the moving object is removed from the captured image.

Since flow line analysis system 500A gives, to schedule control section 50 of the camera, an instruction for a predetermined transmission cycle for transmitting a background image and flow line information of a moving object, it is possible to periodically transmit the background image and the flow line information of the moving object to server 300 according to the transmission cycle for which the instruction is given in advance.

Since flow line analysis system 500A transmits a background image and flow line information of a moving object to server 300 when receiving a notification of detection of a predetermined event (for example, an event such as a change of a layout of a sales area in a store) from event information receiving section 70, server 300 can generate a flow line analysis image in which flow line information regarding staying positions or passing positions of a moving object in an imaging region before and after the time at which the predetermined event is detected is accurately reflected.

Since flow line analysis system 500A transmits a background image and flow line information of a moving object to server 300 when scene identifying section SD detects a change (for example, a change of a layout of a sales area in a store) in a captured image, server 300 can generate a flow line analysis image in which flow line information regarding staying positions or passing positions of a moving object in an imaging region before and after the time at which the change in the captured image is detected is accurately reflected.

In flow line analysis system 500A, since people counting section CT counts the number of detected moving objects included in a captured image and outputs information regarding the number of detected moving objects to transmitter 60, it is possible to display a flow line analysis image including information regarding staying positions or passing positions of a moving object in an imaging region and a display screen (operation screen) including the number of detected moving objects on monitor 450.

Since flow line analysis system 500A does not transmit a background image and flow line information of a moving object in a transmission cycle including the time at which event information receiving section 70 receives a notification of detection of a predetermined event, it is possible to prevent flow line information pieces regarding staying positions or passing positions of a moving object in an imaging region before and after the predetermined event (for example, a change of a layout of a sales area in a store) is detected from being used together when server 300 generates a flow line analysis image.

In flow line analysis system 500A, since report generating output section 360 generates a flow line analysis report including a flow line analysis image generated before detecting a predetermined event (for example, a change of a layout of a sales area in a store) and a flow line analysis image generated after detecting the same event, it is possible to show how flow line information regarding a staying position or a passing position of a moving object in an imaging region changes due to the predetermined event in contrasted and easily understandable manner.

In flow line analysis system 500A, a generated flow line analysis report is displayed on monitor 450 through a predetermined input operation (for example, a user's operation of pressing the report output button), and thus the flow line analysis report can be visually displayed to the user.

In flow line analysis system 500A, since respective cameras 100, 100A, . . . , and 100N perform generation of a background image of a captured image and extraction of flow line information regarding a staying position or a passing position of a moving object included in the captured image, and then server 300 generates and displays a flow line analysis image, a processing load on server 300 can be reduced when compared with a case where server 300 performs generation of a background image of a captured image and extraction of flow line information regarding a staying position or a passing position of a moving object included in the captured image, and thus it is possible to alleviate a limitation on the number of cameras which can be connected to single server 300.

### Modification Example of Present Exemplary Embodiment

In the above-described present exemplary embodiment, the process of generating a flow line analysis image is performed by server 300, but the process of generating a flow line analysis image may also be performed by camera 100 (refer to FIG. 13). FIG. 13 is a block diagram illustrating details of a functional internal configuration of camera 100S of a modification example of the present exemplary embodiment. Camera 100S illustrated in FIG. 13 includes imaging section 10, image input section 20, background image generating section 30, flow line information analyzing section 40, schedule control section 50, transmitter 60S, event information receiving section 70, background image storing section 80, passing/staying analysis information storing section 90, and display image generating section 350S. In description of each section of camera 100S illustrated in FIG. 13, constituent elements having the same configuration and operation as those of camera 100 illustrated in FIG. 2 are given the same reference numerals, and description thereof will be omitted, and differing content will be described.

Display image generating section 350S as an example of an image generating section generates a flow line analysis image in which flow line information regarding a staying position and a passing position of a moving object is superimposed on a background image by using background image data preserved in background image storing section 80 and extraction result data of the flow line information regarding the staying information or the passing information of the moving object preserved in passing/staying analysis information storing section 90 in response to an instruction from schedule control section 50 or event information receiving section 70, and outputs the flow line analysis image to transmitter 60.

Transmitter 60S transmits data on the flow line analysis image generated by display image generating section 350S to server 300.

As described above, in the first modification example of the present exemplary embodiment, camera 100S generates a background image of a captured image of a predetermined imaging region, extracts the flow line information regarding a staying position or a passing position in the imaging region of a moving object (for example, a person) included in the captured image, and generates a flow line analysis image in which the flow line information of the moving object is superimposed on the background image of the captured image by using the background image of the captured image and the flow line information of the moving object.

Consequently, camera 100S generates the background image which is a base of the flow line analysis image so that the moving object (for example, a person) is removed so as not to be shown therein, and can thus appropriately protect privacy of the moving object (the person) shown in an imaging region when a flow line analysis image is generated. Since camera 100S superimposes the flow line information regarding the staying position or the passing position in the imaging region of the moving object (the person) on a captured image which is obtained in real time, it is possible to generate a flow line analysis image which appropriately indicates the latest flow line information regarding the staying position or the passing position in the imaging region of the moving object in a state in which the moving object is removed from the captured image.

Since camera 100S performs a process up to a point of generating a flow line analysis image and transmits flow line analysis image data which is a result of the process to server 300, for example, server 300 may not perform the process of generating a flow line analysis image in a state in which a processing load on server 300 is considerably high, and thus it is possible to minimize an increase in the processing load on server 300.

### History of Reaching additional Examples which will be Described Later

For example, in a case where flow line analysis of a person in a store is performed by using flow line analysis system 500A illustrated in FIG. 1, if a flow line analysis image corresponding to a captured image obtained by a single camera is only displayed on monitor 450, there is a problem in that accurate information regarding staying or passing of a person in a full view or a partial view of a large store (for example, a complex facility in which a plurality of stores are continuously located, such as shopping malls) cannot be obtained, and flow line information of the entire store cannot be overviewed. Similarly, in a large store, there is a high probability that accurate information regarding staying or passing in a situation (for example, a situation in which a person leaves a certain shop and moves to the next shop) around a doorway of a shop may not be obtained. Therefore, in the following Examples, a description will be made of an example of a flow line analysis system displaying a flow line analysis image in which the privacy of a person reflected in a wide imaging region is appropriately protected, and staying information or passing information of a person in the wide imaging region can be easily and accurately checked.

### First Example of Additional Examples of Flow Line Analysis System

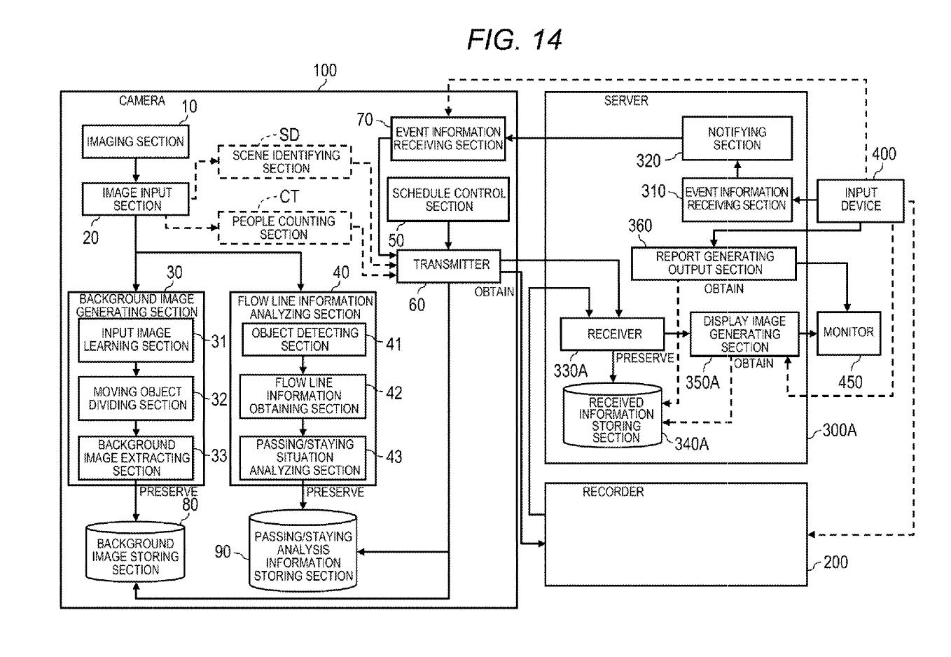

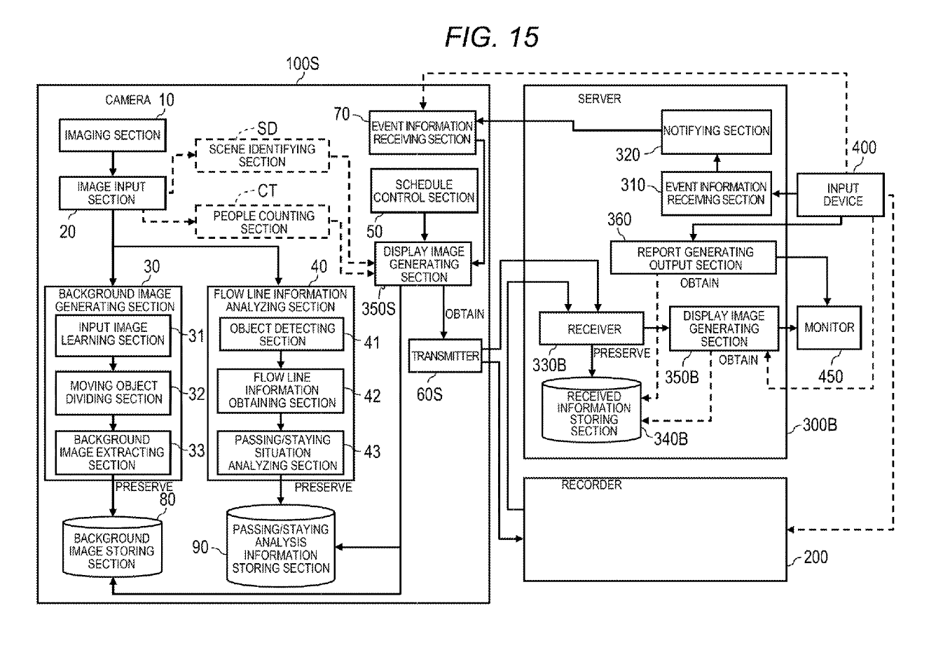

Next, with reference to FIG. 14, a description will be made of another example of a functional internal configuration of each of the camera and the server forming flow line analysis system 500A of the present exemplary embodiment. FIG. 14 is a block diagram illustrating details of another example of a functional internal configuration of each of the camera and the server of the present exemplary embodiment. In camera 100 and server 300A illustrated in FIG. 14, constituent elements having the same configurations and the same operations as those of camera 100 and the server 300 illustrated in FIG. 2 are given the same reference numerals, and description thereof will be made briefly or omitted, and different content will be described. In FIG. 14, a flow line analysis image for each camera is generated by server 300A.

In camera 100 illustrated in FIG. 14, transmitter 60 may transmit data (that is, background image data preserved in background image storing section 80 and extraction result data of flow line information regarding staying information or passing information of a moving object preserved in passing/staying analysis information storing section 90) to be transmitted to server 300A not only to server 300A but also to recorder 200.

Recorder 200 receives the data transmitted from camera 100, and preserves the received data for each camera. If a group (for example, identification information of each camera) of a plurality of cameras and the object date and time (that is, the imaging date and time) required to generate a wide-region flow line analysis image are designated by using input device 400 operated by a user, recorder 200 acquires background image data and extraction result data of flow line information regarding staying information or passing information of a moving object corresponding to a captured image obtained at the object date and time, and transmits the data to server 300A.

In server 300A illustrated in FIG. 14, receiver 330A receives the data (refer to the above description) transmitted from recorder 200 for each camera, and outputs the data to received information storing section 340A and display image generating section 350A.

Received information storing section 340A stores the data received by receiver 330A for each camera. A first example of the data received by receiver 330A is background image data preserved in background image storing section 80 and extraction result data of flow line information regarding staying information or passing information of a moving object preserved in passing/staying analysis information storing section 90 in camera 100. A second example of the data received by receiver 330A is data (that is, background image data and extraction result data of flow line information regarding staying information or passing information of a moving object for each camera, corresponding to a captured image from each camera obtained at the object date and time designated by using input device 400) transmitted from recorder 200.

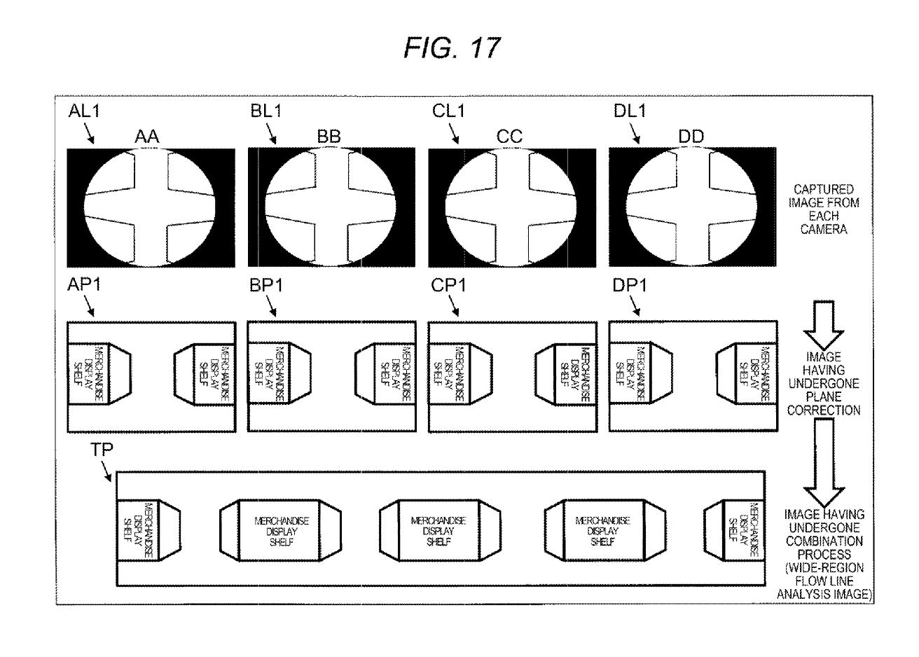

Display image generating section 350A as an example of an image generating section generates a flow line analysis image in which the flow line information regarding the staying position and the passing position of the moving object is superimposed on the background image for each camera by using the data (that is, the data of the first example or the data of the second example) is obtained from receiver 330A or received information storing section 340A. Display image generating section 350A performs a combination process (for example, a stitching process) by using flow line analysis images for the respective cameras so as to generate wide-region flow line analysis image TP (for example, refer to FIG. 17). Display image generating section 350A as an example of a display control section displays the generated wide-region flow line analysis image TP on monitor 450 as a display section.

### Second Example of Additional Examples of Flow Line Analysis System

Next, with reference to FIG. 15, a description will be made of still another example of a functional internal configuration of each of the camera and the server forming a flow line analysis system of the present exemplary embodiment. FIG. 15 is a block diagram illustrating details of still another example of a functional internal configuration of each of the camera and the server of the present exemplary embodiment. In camera 100S and server 300B illustrated in FIG. 15, constituent elements having the same configurations and the same operations as those of camera 100S illustrated in FIG. 13 and the server 300 illustrated in FIG. 2 are given the same reference numerals, and description thereof will be made briefly or omitted, and different content will be described. In FIG. 15, a flow line analysis image for each camera is generated by each camera.

In camera 100S illustrated in FIG. 15, transmitter 60S may transmit data (that is, flow line analysis image data generated by display image generating section 350S) to be transmitted to server 300B not only to server 300B but also to recorder 200.

Recorder 200 receives the data transmitted from camera 100S, and preserves the received data for each camera. If a group (for example, identification information of each camera) of a plurality of cameras and the object date and time (that is, the imaging date and time) required to generate a wide-region flow line analysis image are designated by using input device 400 operated by a user, recorder 200 acquires flow line analysis image data corresponding to a captured image obtained at the object date and time, and transmits the data to server 300B.

In server 300B illustrated in FIG. 15, receiver 330A receives the data (refer to the above description) transmitted from recorder 200 for each camera, and outputs the data to received information storing section 340A and display image generating section 350A.

Received information storing section 340B stores the data received by receiver 330B for each camera. A first example of the data received by receiver 330B is flow line analysis image data generated by display image generating section 350S of each camera 100. A second example of the data received by receiver 330B is data (that is, flow line analysis image data corresponding to a captured image from each camera obtained at the object date and time designated by using input device 400) transmitted from recorder 200.

Display image generating section 350B as an example of an image generating section performs a combination process (for example, a stitching process) by using the data (that is, the data of the first example or the data of the second example) acquired from receiver 330B or received information storing section 340B, so as to generate wide-region flow line analysis image TP (for example, refer to FIG. 17). Display image generating section 350B as an example of a display control section displays the generated wide-region flow line analysis image TP on monitor 450 as a display section.

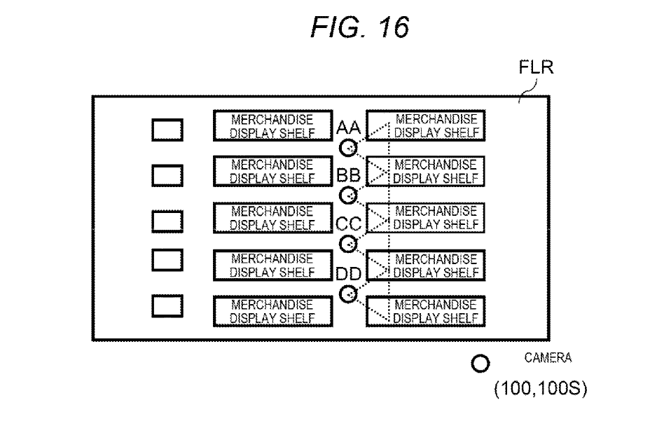

FIG. 16 is a diagram illustrating an example of a layout regarding a merchandise display shelf of a certain wide floor of a store. FIG. 17 is a schematic diagram illustrating examples of procedures of generating wide-region flow line analysis image TP. Floor FLR illustrated in FIG. 16 is, for example, a wide floor of a large store in which a large number of merchandise display shelves are arranged, and it is difficult to understand flow line information of a person having stayed at or having passed a plurality of merchandise display shelves with a single camera. In FIG. 16, for example, states of the respective merchandise display shelves are imaged by, for example, four cameras AA, BB, CC and DD (it is assumed that all cameras have the same configuration as the configuration of camera 100 or camera 100S). In the following description, cameras AA, BB, CC and DD may be fixed cameras respectively having predefined angles of view, and may be omnidirectional cameras having predefined angle of views in directions of 360°. In description of FIG. 17, cameras AA, BB, CC and DD are assumed to be omnidirectional cameras.

An upper part in FIG. 17 illustrates omnidirectional images AL1, BL1, CL1 and DL1 captured by cameras AA, BB, CC and DD. Each of omnidirectional images AL1, BL1, CL1 and DL1 is an image obtained by imaging parts of the merchandise display shelves in all directions.

An intermediate part in FIG. 17 illustrates plane images (that is, two-dimensional panorama images AP1, BP1, CP1 and DP1) obtained by performing a plane correction process (panorama conversion) on the omnidirectional images AL1, BL1, CL1 and DL1 respectively captured by cameras AA, BB, CC and DD. When two-dimensional panorama images AP1, BP1, CP1 and DP1 are obtained by performing plane correction on omnidirectional images ALL1, BL1, CL1 and DL1, for example, a user performs an input operation on input device 400 so as to designate an angle (direction) indicating which direction of omnidirectional images AL1, BL1, CL1 and DL1 is cut.

A lower part in FIG. 17 illustrates wide-region flow line analysis image TP obtained by performing a combination process (for example, a stitching process) on two-dimensional panorama images AP1, BP1, CP1 and DP1. However, for simplification of illustration, in wide-region flow line analysis image TP illustrated in FIG. 17, flow line information regarding staying or passing of a moving object is not shown, and only a background image is shown.

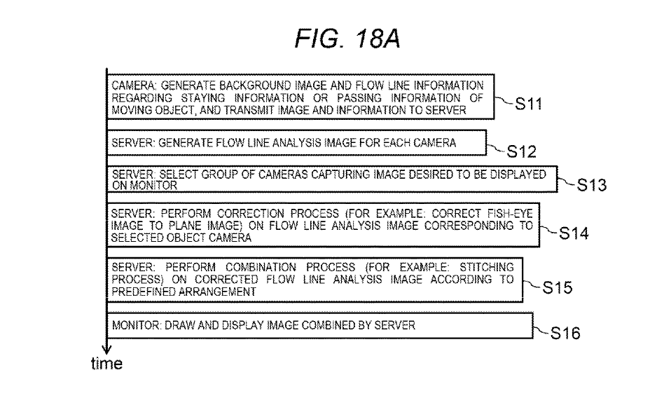

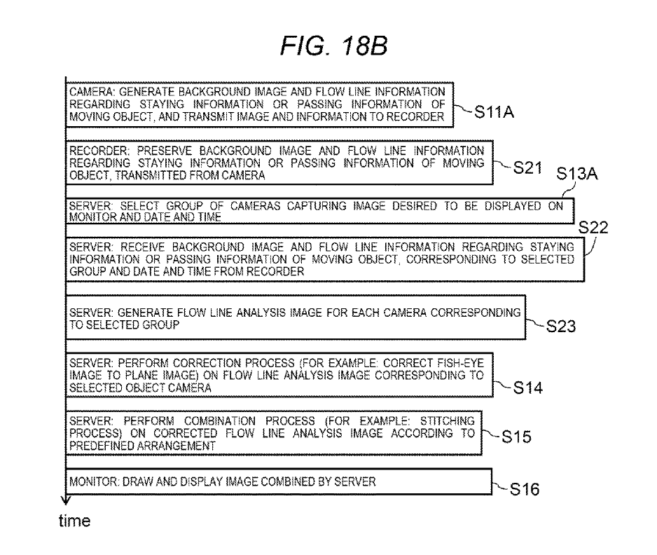

Next, with reference to FIGS. 18A and 18B, a description will be made of operation procedures regarding generation and display of a wide-region flow line analysis image in the first example (refer to FIG. 14) of the additional Examples of flow line analysis system 500A of the present exemplary embodiment. FIG. 18A is a flowchart illustrating first examples of operation procedures regarding generation and display of a wide-region flow line analysis image among a plurality of cameras and the server. FIG. 18B is a flowchart illustrating second examples of operation procedures regarding generation and display of a wide-region flow line analysis image among a plurality of cameras and the server. In the following description, the description has been made of the process in which the camera generates a background image, the process in which the camera extracts flow line information, and the process in which the server generates a flow line analysis image in the present exemplary embodiment, and thus a description of the content of detailed processes will be omitted. In a description of FIG. 18B, the same step numbers are given to the content overlapping a description of FIG. 18A, and the differing content will be described.

In FIG. 18A, each camera 100 generates background image data of an imaging region included in an angle of view thereof and flow line information data regarding staying information or passing information of a moving object (for example, a person), and transmits the data to server 300A (S11). Server 300A generates a flow line analysis image for each camera 100 by using the data (that is, the background image data of the imaging region included in an angle of view of the camera and the flow line information data regarding staying information or passing information of a moving object (for example, a person)) transmitted from each camera 100 (S12).

Here, it is assumed that a user operates input device 400 so as to select a group of cameras 100 capturing images desired to be displayed by the user on monitor 450 (S13). Display image generating section 350A of server 300A performs a correction process on flow line analysis images for a plurality of respective object cameras 100 which are selected through the user's selection operation in step S13 (S14). For example, in a case where a background image of the flow line analysis image for each camera is an omnidirectional image, display image generating section 350A of server 300A performs a correction process for cutting out an image within a range in a direction designated by the user or a predefined direction, so as to generate a two-dimensional panorama image (refer to FIG. 17). For example, in a case where the plurality of cameras 100 are all fixed cameras instead of omnidirectional cameras, the correction process in step S14 may be unnecessary, and thus step S14 may be omitted.

Display image generating section 350A of server 300A performs a combination process (for example, a stitching process) on the flow line analysis images (for example, refer to two-dimensional panorama images AP1, BP1, CP1 and DP1 illustrated in FIG. 17) obtained through the correction process in step S14, according to arrangement set in advance, so as to generate a wide-region flow line analysis image (for example, wide-region flow line analysis image TP illustrated in FIG. 17) (S15). For example, display image generating section 350A of server 300A connects and combines a right end of two-dimensional panorama image AP1 to and with a left end of two-dimensional panorama image BP1 so that the right end of two-dimensional panorama image AP1 and the left end of two-dimensional panorama image BP1 which are adjacent to or overlap each other are continued. Display image generating section 350A of server 300A connects and combines a right end of two-dimensional panorama image BP1 to and with a left end of two-dimensional panorama image CP1 so that the right end of two-dimensional panorama image BP1 and the left end of two-dimensional panorama image CP1 which are adjacent to or overlap each other are continued. Display image generating section 350A of server 300A connects and combines a right end of two-dimensional panorama image CP1 to and with a left end of two-dimensional panorama image DP1 so that the right end of two-dimensional panorama image CP1 and the left end of two-dimensional panorama image DP1 which are adjacent to or overlap each other are continued.

Display image generating section 350A of server 300A displays the wide-region flow line analysis image (for example, wide-region flow line analysis image TP illustrated in FIG. 17) generated in step S15 on monitor 450 (S16). Consequently, server 300A can generate flow line analysis images in which a moving object such as a person is not reflected in a background image and thus the privacy thereof can be appropriately protected for the respective cameras by using individual background images and pieces of flow line information transmitted from the plurality of cameras 100 which capture images in real time. Since server 300A generates a wide-region flow line analysis image through a combination process on flow line analysis images generated by the plurality of cameras 100 and then displays the wide-region flow line analysis image on monitor 450 even in a large store, for example, even in a case where a layout in a floor of the large store which is hardly imaged by a single camera is changed, a user can visually recognize flow line information regarding a staying position or a passing position of a moving object such as a person in a full view or a partial view of the floor.

In FIG. 18B, each camera 100 generates background image data of an imaging region included in an angle of view thereof and flow line information data regarding staying information or passing information of a moving object (for example, a person), and transmits the data to recorder 200 (S11A). Recorder 200 preserves, for each camera 100, the data (that is, the background image data of the imaging region included in an angle of view of the camera and the flow line information data regarding staying information or passing information of a moving object (for example, a person)) transmitted from each camera 100 (S21).

Here, it is assumed that a user operates input device 400 so as to select a group of cameras 100 capturing images desired to be displayed by the user on monitor 450 and the object date and time (that is, the imaging date and time) (S13A). Recorder 200 transmits, to server 300A, background image data of an imaging region and flow line information data regarding staying information or passing information of a moving object (for example, a person), corresponding to the group and the date and time selected by operating input device 400 in step S13A. Server 300A receives the data (that is, the background image data of an imaging region and the flow line information data regarding staying information or passing information of a moving object (for example, a person), corresponding to the selected group and date and time) transmitted from recorder 200 for each camera 100 (S22).

Server 300A generates a flow line analysis image for each camera by using the data (that is, the background image data of an imaging region and the flow line information data regarding staying information or passing information of a moving object (for example, a person), corresponding to the selected group and date and time) transmitted from recorder 200 for each camera 100 (S23). Operations in step S23 and the subsequent steps are the same as those in FIG. 18A, and thus description thereof will be omitted. Consequently, since data transmitted from each camera 100 can be stored in recorder 200, server 300A can generate flow line analysis images in which a moving object such as a person is not reflected in a background image and thus the privacy thereof can be appropriately protected for the respective cameras by using background images and pieces of flow line information for a plurality of respective cameras 100 not in real time but after imaging is performed. Since server 300A generates a wide-region flow line analysis image through a combination process on flow line analysis images generated by the plurality of cameras 100 and then displays the wide-region flow line analysis image on monitor 450 even in a large store, a user selects any date and time, and, thus, for example, even in a case where a layout in a floor of the large store which is hardly imaged by a single camera is changed, the user can visually recognize flow line information regarding a staying position or a passing position of a moving object such as a person in a full view or a partial view of the floor.

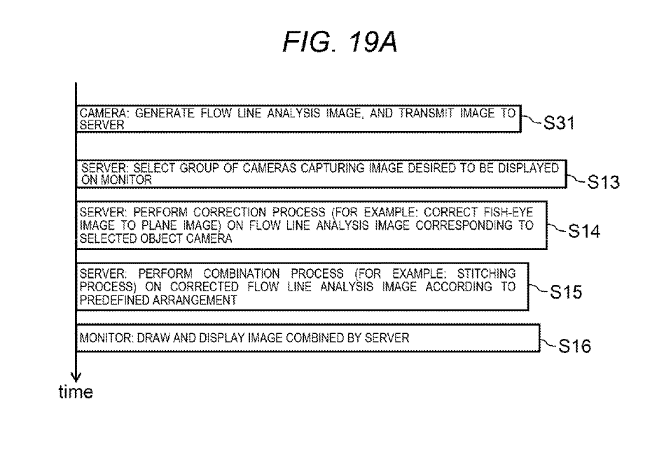

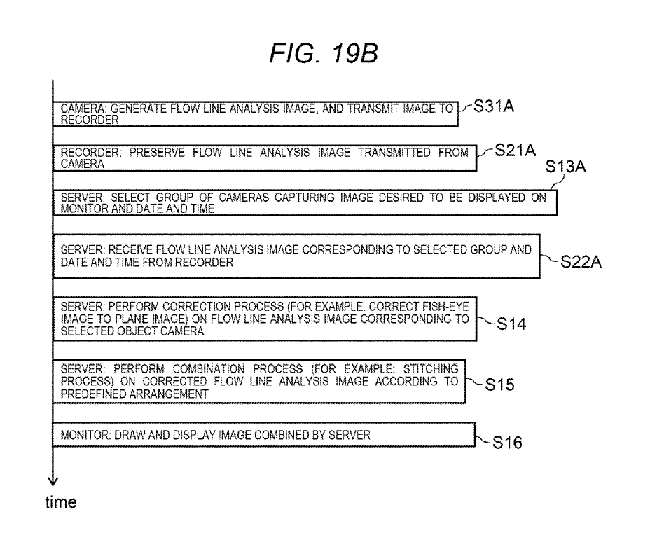

Next, with reference to FIGS. 19A and 19B, a description will be made of operation procedures regarding generation and display of a wide-region flow line analysis image in the second example (refer to FIG. 15) of the additional Examples of flow line analysis system 500A of the present exemplary embodiment. FIG. 19A is a flowchart illustrating third examples of operation procedures regarding generation and display of a wide-region flow line analysis image among a plurality of cameras and the server. FIG. 19B is a flowchart illustrating fourth examples of operation procedures regarding generation and display of a wide-region flow line analysis image among a plurality of cameras and the server. In a description of FIGS. 19A and 19B, the same step numbers are given to the content overlapping a description of FIG. 18A or 18B, and the differing content will be described.

In FIG. 19A, each camera 100S generates a flow line analysis image by using background image data of an imaging region included in an angle of view thereof and flow line information data regarding staying information or passing information of a moving object (for example, a person), and transmits the flow line analysis image to server 300B (S31). Processes in step S13 and the subsequent steps are the same as those in FIG. 18A, and thus description thereof will be omitted. Consequently, each camera 100S can generate respective flow line analysis images in which a moving object such as a person is not reflected in a background image and thus the privacy thereof can be appropriately protected by using individual background images and pieces of flow line information corresponding to capture images obtained in real time. Since server 300B generates a wide-region flow line analysis image through a combination process on flow line analysis images generated by the plurality of cameras 100S and then displays the wide-region flow line analysis image on monitor 450 even in a large store, for example, even in a case where a layout in a floor of the large store which is hardly imaged by a single camera is changed, a user can visually recognize flow line information regarding a staying position or a passing position of a moving object such as a person in a full view or a partial view of the floor.

In FIG. 19B, each camera 100S generates a flow line analysis image by using background image data of an imaging region included in an angle of view thereof and flow line information data regarding staying information or passing information of a moving object (for example, a person), and transmits the flow line analysis image to recorder 200 (S31A). Recorder 200 preserves data regarding the flow line analysis image transmitted from each camera 100S for each camera 100S (S21A).

After step S13A, recorder 200 transmits, to server 300B, data regarding a flow line analysis image in the imaging region, corresponding to the group and the date and time selected by operating input device 400 in step S13A. Server 300B receives the data (that is, the data regarding a flow line analysis image in the imaging region, corresponding to the selected group and date and time) transmitted from recorder 200 for each camera 100 (S22A). Operations in step S22A and the subsequent steps are the same as the operations in step S23 and the subsequent steps in FIG. 18B, and thus description thereof will be omitted. Consequently, server 300B can store the data regarding the flow line analysis image transmitted from each camera 100S in recorder 200. Server 300B generates a wide-region flow line analysis image through a combination process on flow line analysis images generated by the plurality of cameras 100 even in a large store, not in real time but after imaging is performed, and then displays the wide-region flow line analysis image on monitor 450. Consequently, a user selects any date and time, and, thus, for example, even in a case where a layout in a floor of the large store which is hardly imaged by a single camera is changed, server 300B enables the user to visually recognize flow line information regarding a staying position or a passing position of a moving object such as a person in a full view or a partial view of the floor.

The cameras 100 and 100S may be fixed cameras having a fixed angle of view, and may be omnidirectional cameras. Consequently, a user designates a cutout range for generating a two-dimensional panorama image in camera 100 or 100S by using input device 400, and can thus simply and visually check a flow line analysis image indicating flow line information at any location included in an angle of view in a store as a heat map image on monitor 450.

Camera 100 or 100S may count the number of moving objects (for example, persons) included in an image captured by the camera, and may transmit the count information to server 300A or 300B. Consequently, when wide-region flow line analysis image TP is generated, server 300 or 300B can display a detection number (that is, the number of people) of moving objects (for example, person) at a detection position on wide-region flow line analysis image TP and thus enables a user to quantitatively understand a specific detection number.

In flow line analysis system 500A of the present exemplary embodiment, in a case where a person in a store is detected, particularly, information regarding an employee is used for flow line information or information regarding the employee is deleted from flow line information, a name tag including identification information such as a barcode (for example, a two-dimensional barcode or a color barcode) is attached to an employee or the like, the barcode or the like may be detected through image processing in a camera, and then information regarding a person such as the employee may be detected. In this case, flow line analysis system 500A can easily identify an employee in a store, and can thus easily and accurately recognize a working situation of the employee without being not limited to flow line information of a customer.

As mentioned above, although the various exemplary embodiments have been described with reference to the drawings, needless to say, the present disclosure is not limited to the exemplary embodiments. It is obvious that a person skilled in the art can conceive of various modifications or alterations within the scope disclosed in the claims, and it is understood that they naturally fall within the technical scope of the present disclosure.

In the description of the additional Examples, a description has been made of an example in which servers 300A and 300B generate a wide-region flow line analysis image, and, in the servers 300A and 300B, for example, map data regarding a layout of a large store and position information data indicating arrangement locations on the layout of individual cameras 100 and 100S may be preserved in servers 300 and 300B or recorder 200. In this case, servers 300A and 300B may superimpose data regarding a flow line analysis image corresponding to cameras 100 and 100S specified by position information on a map on the map data regarding the layout of the store by using data transmitted from each of a plurality of cameras 100 and 100S or recorder 200, and may display a result thereof on monitor 450. Consequently, a user can simply and visually understand flow line information indicating to what extent a moving object (for example, a person such as a customer) stays or passes on an actual map in a large store in a state in which a moving object is not reflected.

### INDUSTRIAL APPLICABILITY

The present disclosure is useful as a flow line analysis system, a camera, and a flow line analyzing method capable of appropriately protecting the privacy of a person reflected in an imaging region and generating an accurate flow line analysis image in which staying information or passing information of the person is superimposed on a background image which is updated at a predetermined timing.

### REFERENCE MARKS IN THE DRAWINGS

10 imaging section

20 image input section

30 background image generating section

31 input image learning section

32 moving object dividing section

33 background image extracting section

40 flow line information analyzing section

41 object detecting section

42 flow line information obtaining section

43 passing/staying situation analyzing section

50 schedule control section

60 transmitter

70 event information receiving section

80 background image storing section

90 passing/staying analysis information storing section

100, 100A, 100N, 100S camera

200 recorder

300, 600 server

310 event information receiving section

320 notifying section

330 receiver

340 received information storing section

350 display image generating section

360 report generating output section

400 input device

450 monitor

500A, 500B, 500C flow line analysis system

700 smart phone

800 cloud computer

900 setting terminal

1000 sales management system

CT people counting section

SD scene identifying section

1. A flow line analysis system comprising:
a plurality of cameras; and
a server that is connected to the cameras,
wherein each of the cameras
captures an image of a differing imaging region,
repeatedly generates a background image of a captured image of the imaging region,
extracts flow line information regarding a staying position or a passing position of a moving object in the imaging region of the camera, included in the captured image, and
transmits the generated background image and the extracted flow line information of the moving object to the server at a predetermined transmission cycle, and
wherein the server
acquires flow line analysis images based on superimposition between the background image of the captured image and the flow line information of the moving object for each camera,
generates a wide-region flow line analysis image by using the plurality of acquired flow line analysis images, and
displays the generated wide-region flow line analysis image on a display section.

2. The flow line analysis system of claim 1, further comprising:
a recorder that stores the background image of the captured image and the flow line information of the moving object for each camera in correlation with each other,
wherein, in response to an operation of designating the date and time and the plurality of cameras, the server acquires, from the recorder, the background image of the captured image and the flow line information of the moving object, corresponding to captured images obtained by the plurality of cameras at the designated date and time, generates the wide-region flow line analysis image by using flow line analysis images based on superimposition between the background image of the captured image and the flow line information of the moving object acquired from the recorder, and displays the wide-region flow line analysis image on the display section.

3. The flow line analysis system of claim 1,
wherein at least one of the cameras is an omnidirectional camera which can capture an omnidirectional image of the imaging region of the camera, and
wherein the server converts an omnidirectional image of the imaging region captured by the omnidirectional camera into a plane image, generates the wide-region flow line analysis image by using the plane image as a result of the conversion, and displays the wide-region flow line analysis image on the display section.

4. The flow line analysis system of claim 1,
wherein the camera counts the number of detected moving objects included in the captured image obtained by the camera, and transmits information regarding the counted number of detected moving objects to the server, and
wherein the server displays, on the display section, the wide-region flow line analysis image in which the number of detected moving objects is further superimposed by using the information regarding the number of detected moving objects transmitted from the camera.

5. A flow line display method for a flow line analysis system in which a plurality of cameras are connected to a server, the method comprising:
causing each of the cameras
to capture an image of a differing imaging region,
to repeatedly generate a background image of a captured image of the imaging region,
to extract flow line information regarding a staying position or a passing position of a moving object in the imaging region of the camera, included in the captured image, and
to transmit the generated background image and the extracted flow line information of the moving object to the server at a predetermined transmission cycle; and
causing the server
to acquire flow line analysis images based on superimposition between the background image of the captured image and the flow line information of the moving object for each camera,
to generate a wide-region flow line analysis image by using the plurality of acquired flow line analysis images, and
to display the generated wide-region flow line analysis image on a display section.
